(19) United States
(12) Patent Application Publication
(10) Pub. No.: US 2012/0233011 A1
(43) Pub. Date: Sep. 13, 2012

(54) Residual Value Bidding System and Turbo Auction

(76) Inventor: E. Buckley Barlow, South Jordan, UT (US)

(21) Appl. No.: 13/414,193

(22) Filed: Mar. 7, 2012

Related U.S. Application Data
(60) Provisional application No. 61/450,592, filed on Mar. 8, 2011.

(51) Int. Cl. G06Q 30/08

(52) U.S. Cl. 705/26.3

(57) ABSTRACT

An auction service may allow auction sponsors to interact with a customer through online and offline methods. Customers may receive a portion of the value of paid bids used in auctions returned as stored value to be used with an auction sponsor. Customers may also receive discounts, incentives and offers that provide more value to the customer, which may ease or remove the feeling of losing money. Customers may also perform actions in the real-world that earn rewards in the online world and vice versa. Thus customers may be encouraged to interact in-store and online with the sponsor.

### RELATED APPLICATIONS

The present application claims the benefit of U.S. Provisional Application Ser. No. 61/450,592, filed Mar. 8, 2011, which is expressly incorporated herein in its entirety.

### THE FIELD OF THE INVENTION

The present invention relates to auctions. More specifically, the present invention relates to a residual value bidding system and to turbo auctions.

### BACKGROUND

Auction systems are part of entertainment shopping. They provide customer excitement on bidding for various products, hoping for a great deal. Yet, that excitement can lead to disappointment, when the customer does not win the auction. This disappointment can be even stronger, when a pay-per-bid model is used.

Businesses are sensitive to people's brand experiences. Thus, a business may be reluctant to associate their brands with negative experiences. This may include the current model of auctions, especially pay-per-bid auctions where money is spent on each bid.

However, auctions, especially online penny auctions may be a source of buzz and excitement for brands. A sponsorship of an auction may benefit both the brand awareness, as well as the auction. Yet it is the negative experience that provides an obstacle between the brand and the auction.

Thus, there is a need to generate the buzz of an auction for a brand without the disappointment.

### SUMMARY OF THE INVENTION

It is an object of the present invention to provide an improved a residual value bidding system with online and offline interaction.

According to one aspect of the invention,

These and other aspects of the present invention are realized in a residual value bidding system with online and offline interaction as shown and described in the following figures and related description.

### BRIEF DESCRIPTION OF THE DRAWINGS

Various embodiments of the present invention are shown and described in reference to the numbered drawings wherein:

FIG. 1 shows an overview of customer interaction with a residual value bidding system with online and offline interaction;

FIG. 2 shows a chart highlighting the interactions and benefits of a residual value bidding system with online and offline interaction;

FIG. 3 shows a customer interaction flow chart of a residual value bidding system with online and offline interaction;

FIG. 4 shows a sponsor interaction flow chart of a residual value bidding system with online and offline interaction;

FIG. 5 shows a configuration display of a residual value bidding system with online and offline interaction;

FIG. 6 shows a hardware diagram of a residual value bidding system with online and offline interaction;

FIG. 7 shows a system overview of a residual value bidding system with online and offline interaction;

FIG. 8 shows a bid system diagram of a residual value bidding system with online and offline interaction;

FIG. 9 shows a bid system module diagram of a residual value bidding system with online and offline interaction;

FIG. 10 shows an overview diagram of an auction system with turbo bidding;

FIG. 11 shows a system diagram of an auction system with turbo bidding;

FIG. 12 shows a diagram of modules contained within a turbo bidding engine;

FIG. 13 shows a flowchart of an auction system with turbo bidding process;

FIG. 14 shows a flowchart of a turbo bidding engine;

FIG. 15 shows a flowchart of person counting module of a turbo bidding engine;

FIG. 16 shows a screenshot of a customer interface to the turbo bidding system;

FIG. 17 shows a diagram of the offer system of a residual value bidding system with online and offline interaction;

FIG. 18 shows a system connection chart of an auction giftcard redemption system;

FIG. 19 shows a giftcard redemption chart;

FIG. 20 shows a flowchart of a giftcard purchase and delivery system;

FIG. 21 shows a flowchart of an auction giftcard redemption system;

FIG. 22 shows a flowchart of an auction giftcard redemption system with reloading;

FIG. 23 shows an auction delivery configuration screen;

FIG. 24 shows a giftcard selection screen;

FIG. 25 shows a giftcard redemption screen;

FIG. 26 shows a multimedia receipt screen;

FIG. 27 shows a text message receipt screen;

FIG. 28 shows an interactive text message query redemption screen;

FIG. 29 shows an interactive multi-media message query redemption screen;

FIG. 30 shows an interactive text message amount query result screen;

FIG. 31 shows a diagram of the traffic incentive system for offline traffic;

FIG. 32 shows a diagram of the traffic incentive system for online traffic;

FIG. 33 shows a diagram of a residual value bidding system;

FIG. 34 shows a flowchart of a residual value bidding system;

FIG. 35 shows a flowchart of a residual value bidding system with bidding rewards;

FIG. 36 shows a system overview diagram of a residual value bidding system;

FIG. 37 shows a system diagram of a residual value bidding system;

FIG. 38A shows a residual value bidding memory module diagram;

FIG. 38B shows a residual value bidding module mock-up;

FIG. 39 shows a mock-up of a modular bidding site with residual value bidding system;

FIG. 40 shows a screenshot of a modular bidding site with residual value bidding system;

FIG. 41 shows a store interaction diagram;

FIG. 42 shows a diagram of multi-system analytics; and

FIG. 43 shows a diagram of an API integration system.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

A residual value bidding system with online and offline interaction may provide the excitement and entertainment value found in online auctions and online penny auctions without the let-down of the winner-take-all ending. As bids are used, the bidder accrues a residual value of the cost of bids used. After the auction ends, the residual value of the bids may be used to purchase the item up for bid or returned in the form of stored value, such as a giftcard or coupon. In other words, a percentage of the bid cost (residual value) may be returned to a bidder in a form that may be used to defray or cover the cost of future purchases (stored value) through mediums such as gift cards, electronic gift cards, coupons, coupon codes, debit cards, pre-paid cards or other stored value containers.

The system may further encourage online interactions to drive customers to a sponsor store visit and/or offline interactions to drive customers to visit the online system. By having these interactions online and offline, customers are encouraged to interact frequently with the system.

A sponsor may be an entity that participates in the system to provide goods or services to customer. A sponsor may be a retailer who wishes to sell products, such as an electronics chain. A sponsor may be a service provider who wishes to sell services, such as a plumber. A sponsor may even be a non-profit, wherein the non-profit may use the system as a fundraiser.

While the interactions described may focus on stores as a physical place, it should be recognized that many of the principles, objectives and actions may be translated into an online-store. In-fact, many online interactions may be easier to track than offline interactions.

While the term in-store is intended to be applicable to online and physical stores, occasionally the method or apparatus may only be directly applicable to one kind of store. It should be recognized that the principle being taught may be still used in a similar sense for the other kind of store. For example, in-store foot traffic may be correlated with the online equivalent of website visits or pageviews.

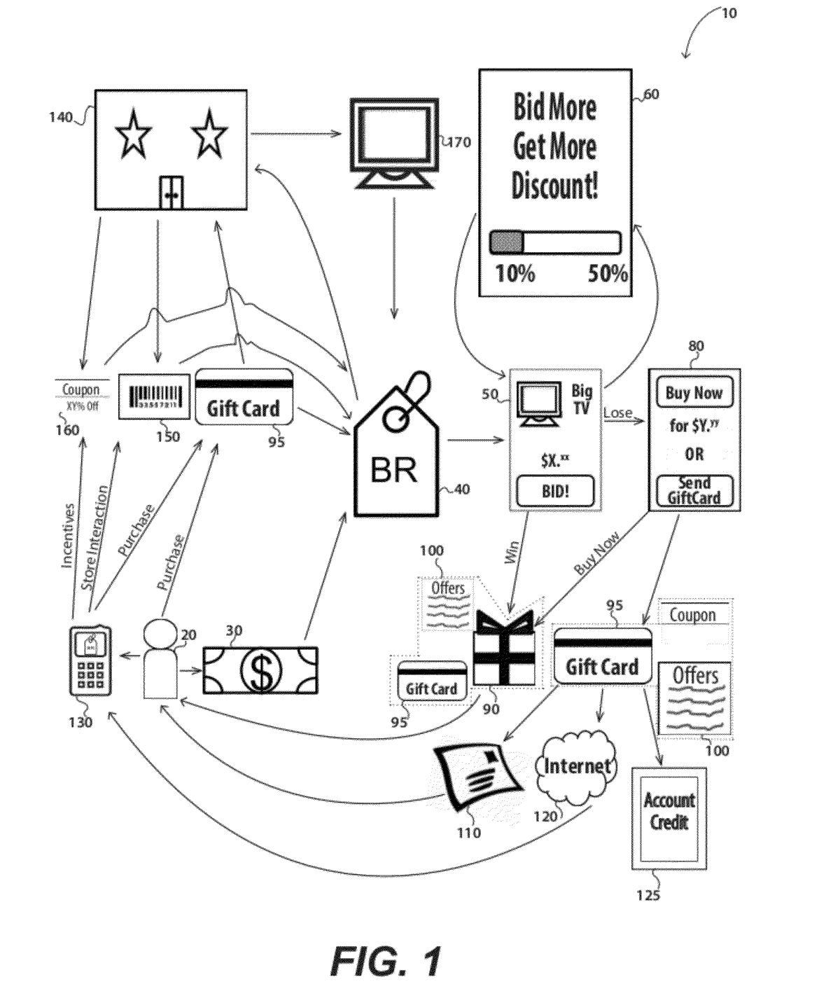

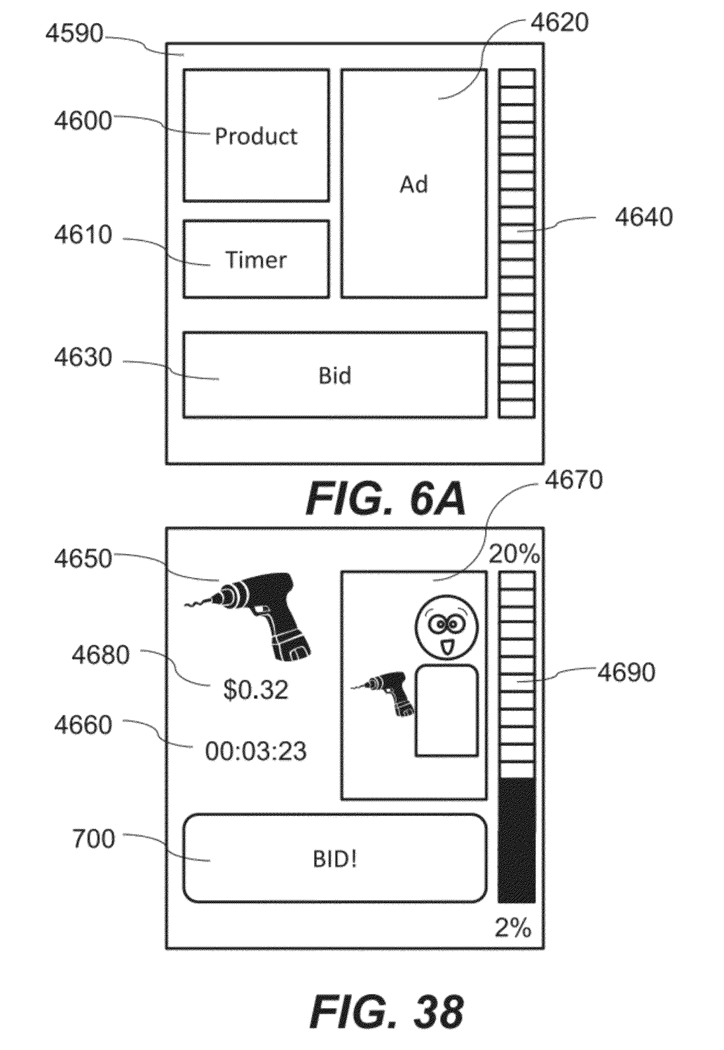

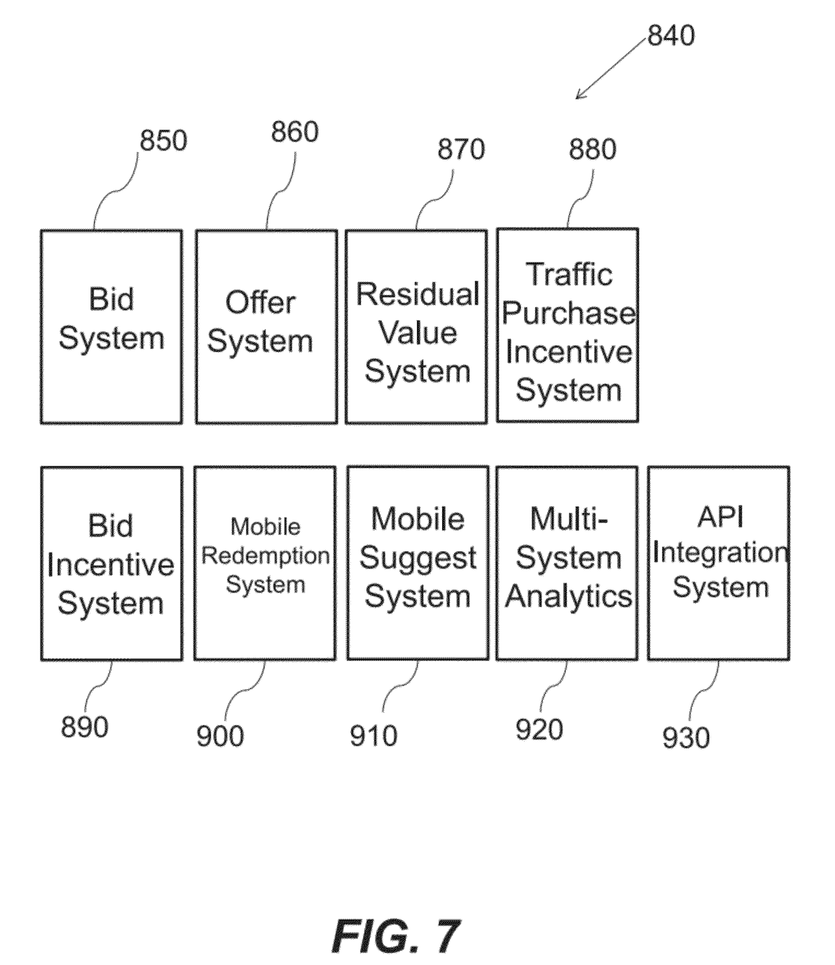

FIGS. 1 to 7 discuss a high level view of the system and interactions between system elements. FIGS. 8 to 43 discuss various elements of the system at various depths of treatment. These elements may include a bid system, offer system, residual value system, traffic purchase incentive system, mobile redemption system, mobile suggest system, multi-system analytics and an API integration system. These systems are described in FIG. 7 and beyond.

Turning now to FIG. 1, an overview of customer interaction with a residual value bidding system with online and offline interaction is shown. A customer 20 pays money 30 to a service provider 40, which provides bids to the customer 20. The customer 20 may then bid on an auction 50 with any bids available to the customer 20. As the customer 20 bids on an auction 50, the customer may receive increasing incentives 60 to encourage further bidding.

If the customer 20 loses the auction 50, the customer 20 may be presented with an opportunity 80 to purchase the auction item using the residual value from prior bids, any applicable incentives earned and any discount the auction sponsor desire. If the customer 20 chooses to purchase the item 90, the customer 20 may use all or part of the residual value depending on whether the customer's 20 residual value exceeds the buy now price minus any discounts. If the customer 20 chooses to not buy now, the residual value may be sent to the customer by stored value, such as a gift card 95 or coupon.

If the customer 20 wins the auction 50, the customer 20 may receive the item 90 won. The customer 20 may also receive the residual value of the bids placed. In some cases, the customer 20 may choose to apply the residual value against the bid price of the item and shipping. Any remaining residual value may then be delivered by stored value.

As the winner or loser receives residual value bid cost through stored value and an opportunity to purchase the item 90, customers 20 are encouraged to place bids. Furthermore, customers 20 may leave an auction feeling happy, as they still receive residual values, incentives and offers.

Win or lose, all customers 20 may receive special offers 100 tailored to them. These offers further reduce the feeling of losing money in the bidding process. In fact, in some cases, the residual value, bidding incentives and special offers may add up to more than the cost of the bids placed. This allows a customer 20 to feel like they received a good deal along with entertainment. Sponsors may like the system because a customer is not likely to leave with a bad experience.

Customers 20 may receive their stored value in multiple ways. In one embodiment, a customer may pre-determine a preference for delivery of stored value. After the auction, the system may check the preference and send the stored value accordingly. This may include a physical item by mail 110, electronic delivery by the internet 120 or a credit to an account 125. Electronic delivery may include delivery to a phone 130, such as by an application, text messaging, MMS, or delivery to a computer, such as by email, computer download, or a document.

As the customer 20 now has stored value, the customer may be more likely to visit a store 140 that accepts the stored value for payment. Upon arrival, the customer may receive an alert with any special deals or information on their phone, such as an in-store coupon 160. Should the customer desire, the customer 20 may purchase an item using the stored value, such as gift card 95. The customer may also receive requests to interact with the store 150, such as a request from their phone 130. As the customer 20 performs actions within the store 140, the actions may be reported to the service 40.

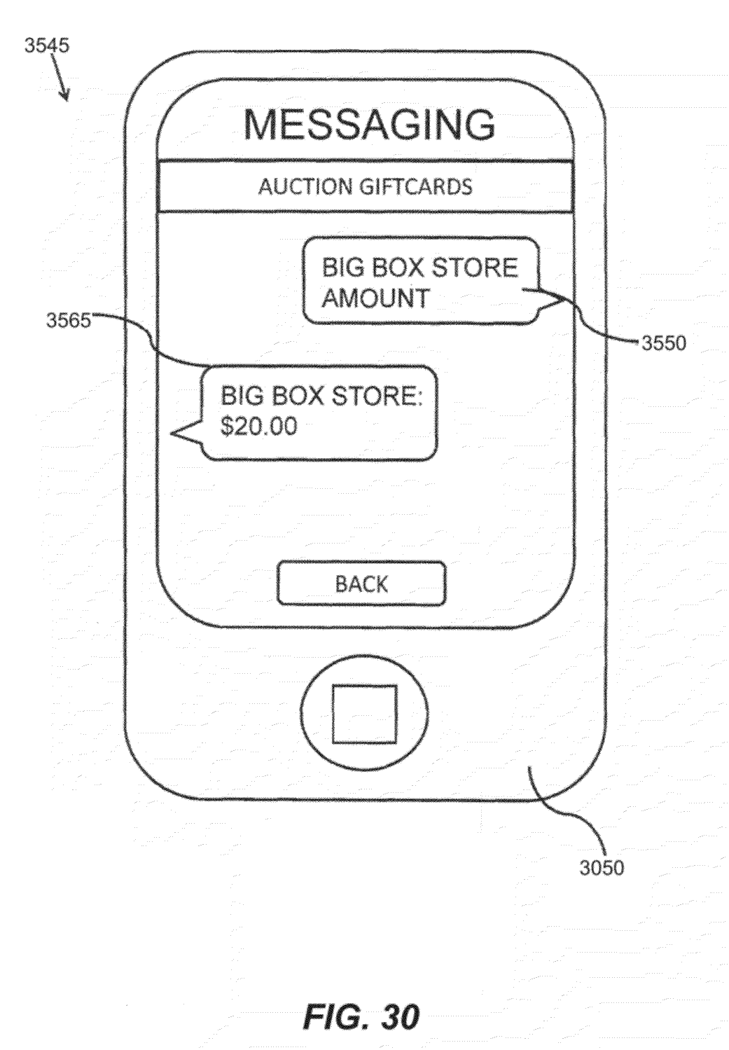

Store interactions may be used to glean further information from the customer. Interactions may include surveys, UPC scans of items desired, self-made videos, comments or other customer feedback. The store 140 may provide incentives to provide this feedback, such as giving coupons or free bids. The store 140 may use this information to make decisions, such as placing a frequently requested item 170 up for bid with the service 40 in response to customer 20 feedback. Further discussion may be found in association with FIG. 31.

Bids may come in two types, promo bids and regular bids. Promo bids may be obtained through actions such as coupon use or survey responses. Normal bids may be purchased. Typically, promo bids have no residual value, while normal bids have residual value. Residual value may be part or all of the cost of used bids that are returned to a customer 20 as stored value. In some promotions, however, an auction sponsor may choose to provide residual value for some or all bids.

Residual value may be configured by the auction sponsor to achieve goals. For example, amounts of residual value may be changed to increase profit or drive bids. Thus a small residual value may be used on popular items to achieve more profit. A larger residual value may encourage more buy now purchases, social traffic or total bids placed. In some cases, a sponsor may wish to have a negative return on the campaign to increase top of mind awareness.

Residual value may also be targeted according to the needs of the sponsor through stored value containers. In some cases, a sponsor may wish to only allow the residual value to be applied to a specific item, such as through a redeemable coupon. In other cases, the sponsor may want to limit the residual value to a class of items, such as through a redeemable dollar-off coupon. In yet other cases, the sponsor may wish to make the residual value apply to their stores, such as through a gift card. Sometimes, such as when sponsors own more than one brand of stores, the residual value may apply to a group of stores, such as through a more generic gift card. Should the sponsor choose, the sponsor may also send out stored value that may be used anywhere the stored value container is accepted, such as a pre-paid card.

Offers may help make up the difference between the purchase price of the bids and the residual value of the bids and incentives. In some cases, sponsors may provide offers that may be correlated to customer profiles and/or bidding patterns. Thus a customer 20 may receive relevant offers that provide a perceived value.

The customer may be rewarded for each step taken in the system. As can be seen from this graphic, the customer is encouraged to interact with the store 140 at both the storefront and through the on-line service 40. Storefront interaction encourages the customer 20 to earn online rewards, such as free bids for surveys or purchases. Online interaction, such as bids, may earn in-store incentives, such as coupons. As each action earns rewards toward a different part of the system 10, a cycle may be created between on-line and in-store interactions. In one embodiment, customers may be driven in-store to utilize their residual value. The customers may be invited to interact with the store by scanning desired auction items, surveys and other feedback in exchange for promo bids. Similarly, the customer may receive bids for spending the residual value. These bids may then drive the customers back to the service 40 to place further bids. Thus a merchant may be able to both increase foot traffic at stores while increasing online interaction with their products and brands.

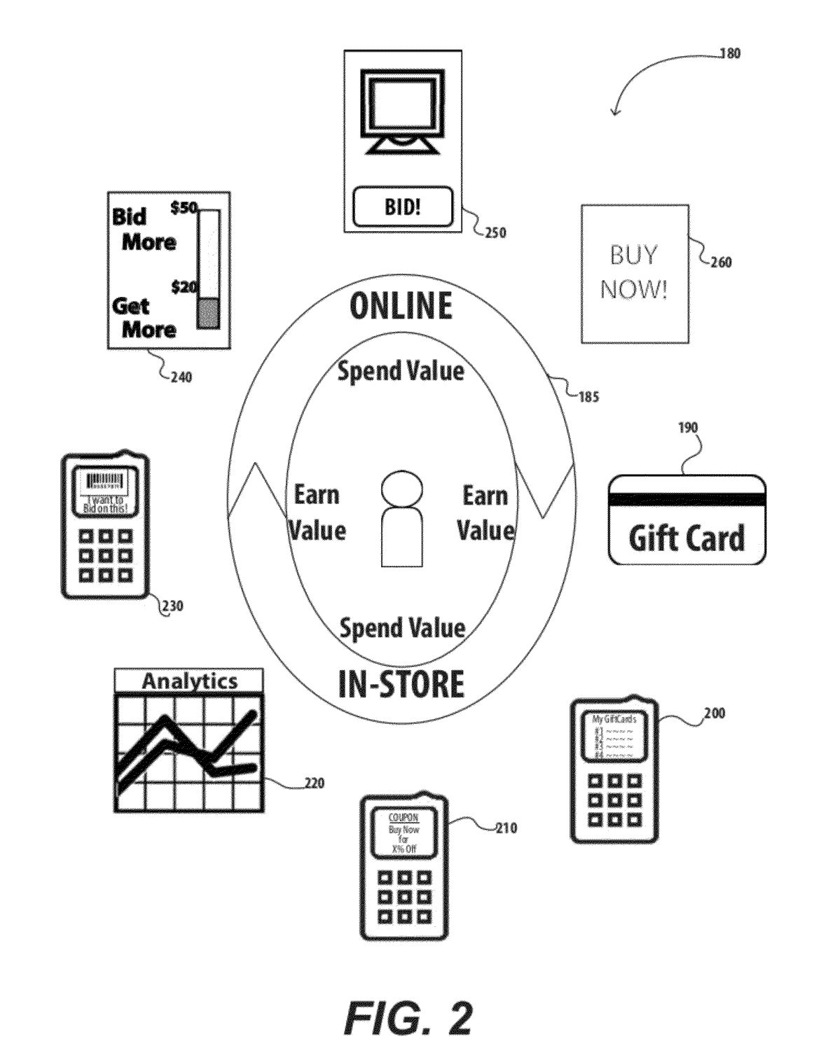

Turning now to FIG. 2, a chart highlighting the interactions and benefits of a residual value bidding system with online and offline interaction is shown. Through earning value and spending value, a system 180 may be designed to encourage customer behavior to interact with the system both online and offline in a virtuous cycle 185.

A customer may be driven from the on-line service to in-store through some buy now links, stored value, smart phone application, in-store purchasing incentives and analytics. The buy now system 260 may provide for in-store pick-up instead of shipping, driving in-store traffic. The stored value may drive customers 20 to the store to use the stored value on desired items. A smart phone application 200 may store multiple gift cards and serve reminders for a customer to spend outstanding balances, further driving traffic. In one embodiment, the stored value sponsor may control the timing of the reminders to drive traffic during slow times or end of period sales. Another module within the smart phone may provide for incentives through the traffic purchase incentives system 210, such as coupons for customers within the stores. Use of the coupon may encourage current purchase while rewarding the customer with bids to use online and driving traffic to the web service.

Analytics 220 may be used to understand the behavior of customers 20 such that more desirable auctions may be placed online and effective incentives/coupons may be used to encourage on-line and in-store purchases. Store interaction 230 may be used to gather information and reward customers for thinking about or recommending the stores, such as with bids that may drive more online traffic. Bid incentives 240 encourage more bidding the present while rewarding the customer with value that may be used in-store. The bidding system 250 may provide entertainment while further fueling the desire for the object bid upon. The buy now system 260 may be used to satiate the desire for purchase created in the bidding system 250. Thus, the system 180 may continuously reward and drive a customer both online and in-store.

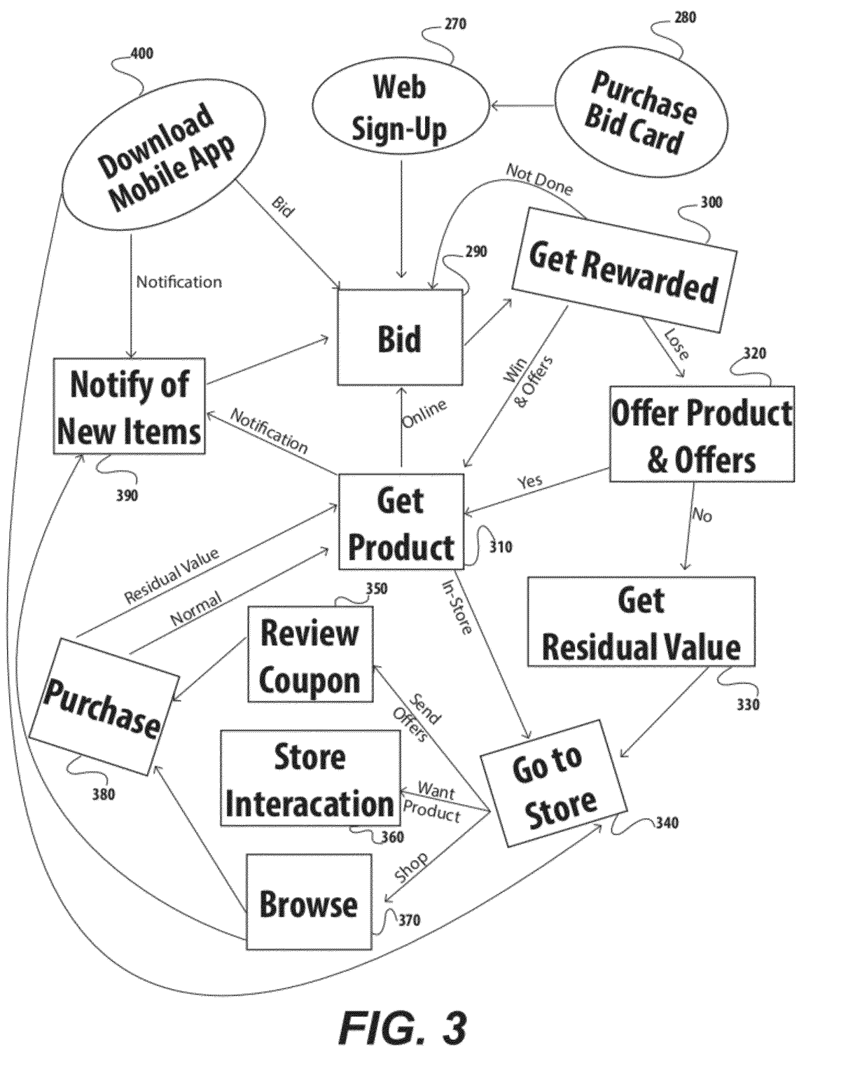

Turning now to FIG. 3, a customer interaction flow chart of a residual value bidding system with online and offline interaction is shown. Either through a purchase of a bid gift card 280 or a web sign-up 290, a customer may create an account. Once signed up for the service, a customer may choose to bid 290 on auctions. As the customer places more bids, they may get rewarded 300. If a customer wins the auction, they may receive the product, residual value and offers. If the customer does not win the auction, they may be offered the product 320 and receive offers. If the customer accepts the offer, the customer may receive the product 310 and any leftover residual value. If not, the customer may receive the residual value of the bids 330 as stored value, such as a gift card.

After receiving the product and/or stored value, a customer may desire to visit the sponsor store 340 to spend the value. In some cases, receipt of the product may require redemption of an in-store pickup, such as voucher for the product. At the store, the customer may receive purchase incentives 350, interact with the store 360 or browse the store for goods 370.

The store may send purchase incentives 350 to the customer. A purchase incentive is a communication from the sponsor and/or service that encourages a customer to make purchases. For example, the store may send coupons to the customer based on demographics, profile information, bidding history or other information available to the sponsor. Similarly, a customer may be reminded of upcoming events that may affect the customer. For example, a hardware store may send winter weather warnings to a customer in their store to drive sales of winter preparation products such as snow melt and snow shovels. Purchase incentives may come with rewards, such as promo bids offered for purchase of winter preparation products.

The customer may also interact with the store 360. In some embodiments, store interaction may occur through an application on a smartphone. Store interaction may include surveys, UPC scans of items desired, self-made videos, comments or other customer feedback. For example, a customer may be offered a reward of free bids to scan three items they desire to be placed up for bid. In another example, a store may request a video recommendation of a product within a store to send to a social media site. Interaction may also be rewarded according to a sponsor's desired reward and/or the service. Interaction with a store may not require the store be affiliated with the service. In fact, the service may use and reward such information, such as scanned UPC codes, to further recruit stores and/or determine popular products. Similarly, the store may provide kiosks for those without smartphones to encourage interactions, such as surveys, and provide rewards through the service.

The customer may also browse 370 the store. In some embodiments, the store may provide self-service applications. In fact, in one embodiment, the customer may scan a UPC code on their phone to return a price look-up without having to search for one hidden in an aisle. The price look-up information may used by the store to further discover potential incentives for the customer. In one embodiment, if a customer looks up a price, the system may return the item with a review of the product and/or product purchasing advice. In another embodiment, a customer at an auto-store may scan an item, such as an air filter, and confirm it will fit in their model of car.

One advantage of the system is that it may detect the customer within the store, such that purchase incentives may be timely given. For example, a sponsor may know that a customer has been bidding on a brand of clothing, but has not yet been successful in winning. When the customer arrives at the store, the customer may receive a coupon offering a discount on the brand of clothing. With that timely and personal delivery, a customer may decide to make that purchase.

Rewards may be specific or generic, similar to the stored value discussion above. When specific rewards are used for bid incentives, such as percentage off of a specific item, the sponsor may be able to tailor the actual value of the coupon in light of profit margins. For example, a 10% coupon off a $100 retail item is actually worth $10. Furthermore, a specific reward may encourage buy now behavior after the auction, as failure to use the reward would feel like a loss of value. In some cases, however, it may be desirable to use a more generic class coupon, store reward or other generic money, service or product reward. For instance, it may be desirable to give a customer a coupon for a percentage off a class of flat screen televisions, as the specific model of television may or may not be in stock at all stores.

If the customer decides to purchase an item 380, the customer may use the residual value on a stored value container or simply purchase the item 310. In either case, the system may utilize the in-store information gleaned from customer interaction to notify the customer 390 of potentially interesting new items available bid upon. Thus the customer may be driven back on-line from a store setting.

In some cases, the customer may enter this process by downloading a mobile app 400 instead of a web-sign up 270. With a mobile app, the customer may start receiving notifications 390, start placing bids 400 or go to the store 340.

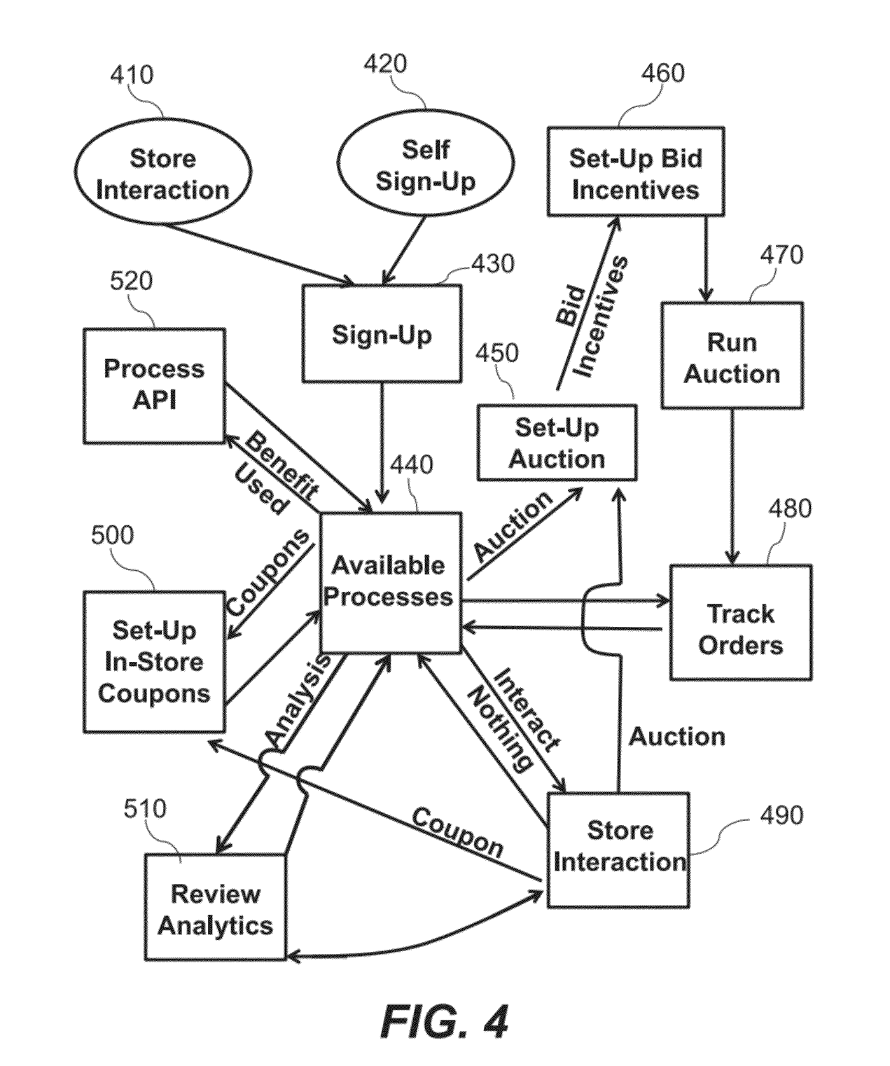

Turning now to FIG. 4, a sponsor interaction flow chart of a residual value bidding system with online and offline interaction is shown. A sponsor may decide to sign up with the service 430 because of interest in the service 420 or because their customers have been interacting with the service 430. Once signed up, the sponsor may set-up auctions 450, create store interactions 490, review analytics 510, set-up rewards 500 and integrate their systems with the service through a process API 520.

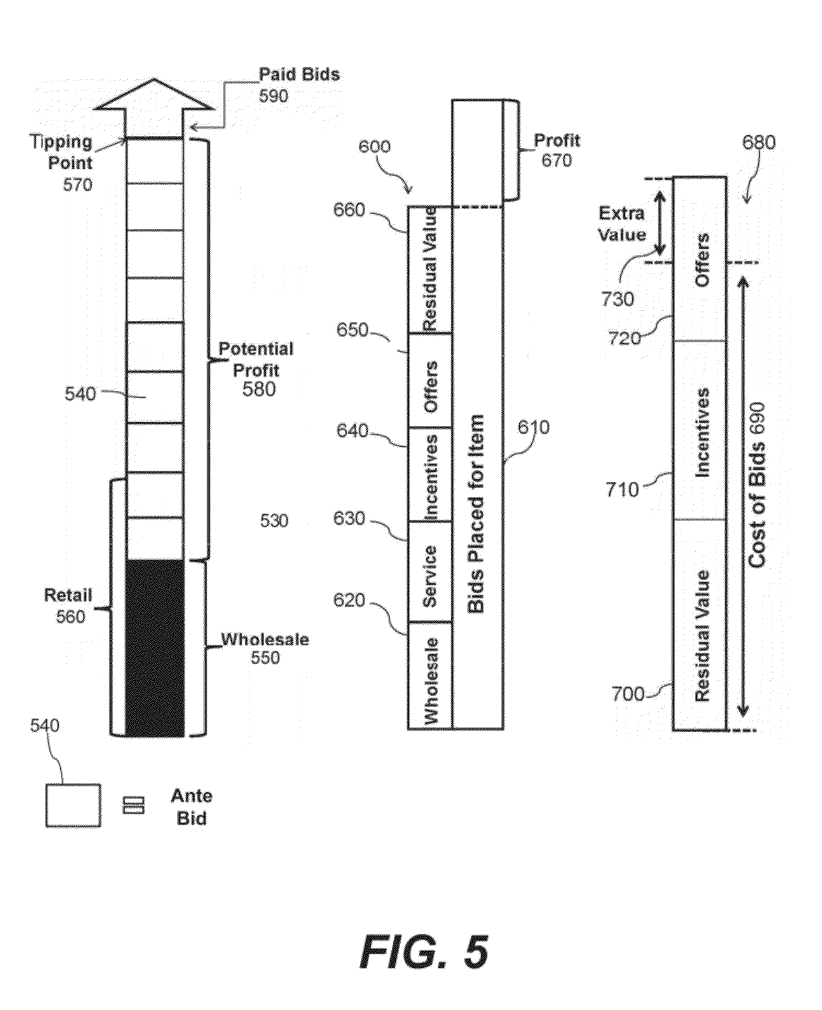

A sponsor may choose to begin by setting up an auction 450 for a product or service. The sponsor may setup such information as residual value given, buy now discounts, offers, bid antes, tipping point and other information (See FIG. 5 discussion). In one embodiment, the system will show the sponsor a graph of predicted outcomes based on costs, settings and bids. The sponsor may also choose bid incentives 460 to encourage customers to bid. Once setup, the sponsor may make the auction live 470. The sponsor may monitor and track orders 480, fulfilling them manually if necessary until connected with the process API.

The sponsor may select to review and create store interaction 490. The store may set-up technologies and desired actions. Technologies may include kiosks, near-field communications (for payment, downloading coupons, or URL's), in-store detection, gift cards, and electronic gift cards. Desired actions may include surveys, recommendations, desired products, social media postings, and self-made videos. Each action may include a reward. The store interaction module may prompt the sponsor to create a reward and set-up rewards and in-store coupons 490.

Recommendations and social media suggestions may be very powerful because of the trust relationship between the customers and their friends. Recommendations may be tracked such that a sponsor may use the customer's recommendation on their online store when the customer's friend views the store and/or the product page recommended. In one embodiment, a customer sends a video recommendation of a store's washing machine to her friend. When her friend uses a link associated with the video, the friend is taken to the washing machine product page with the video recommendation embedded next to a picture of the washing machine. The customer may further provided a coupon to encourage the immediate purchase.

The sponsor may review analytics 510 and act upon them. Customer interactions with the system may be recorded and reported to the sponsor. These reports may be aggregate reports and may have the ability to drill down into personal information. In some embodiments, the service may shield personal information shielded unless required to complete a transaction (such as shipping information). Should the sponsor discover trends, the sponsor may create link directly to a corresponding module to capitalize on the trend. For example, upon discovery that many people are visiting an auction for a video game in the analytics module 510, the sponsor may link to the store interaction module 490 and create interactions based around the video game including a set of promo bids for purchase of the game.

The sponsor may choose to set-up rewards and purchase incentives 500, such as in-store coupons. Many settings may be available. Settings may include type of offer (buy one get one, free trial, percentage off, dollar amount off, dollar matching, etc.) restrictions (date, product, geographic, etc.), profile matching vs. blanket offer, and promo bids offered.

If the sponsor chooses, the sponsor may integrate with the process API. The process API may allow the sponsor to direct information directly to their systems. This direction of information may aid in gift card purchases, order fulfillment, analytics for reporting and financial information. In one embodiment, the sponsor may choose to receive the initial payment and be invoiced by the service to avoid service fees. In another embodiment, the sponsor may choose to have funds collected by the service minus fees deposited into a bank account.

Turning now to FIG. 5 shows a configuration display of a residual value bidding system with online and offline interaction is shown. The system may include a display with several graphs to help a sponsor understand the consequences of the current configuration. These may include a tipping point graph 530, a profit prediction graph 600 and a customer value graph 680.

The tipping point graph 530 may help the sponsor understand the initial startup configuration of an auction. In one embodiment, the auction may use a tipping point 570 calculation which requires a number of ante bids 540 before the auction will be honored. An ante bid 540 may allow a customer to bid on an auction, when it opens. The ante bids may require multiple bids as the “ante.” Ante bids allow the sponsor to assure enough money comes in to cover the auction, if desired. If the ante bids are insufficient to reach the tipping point 570, the ante bids may be returned.

The tipping point graph may aid in the sponsor understanding the costs involved and the desired return on investment during the setup of the auction. The graph may include such costs as wholesale cost 550. The graph may include information showing where the retail value would lie on the graph. Profit from the ante bids may be shown, as well as information about where paid bids would contribute to the graph.

The profit prediction graph may be used to estimate profit with estimated traffic and configuration. Costs may be stacked against the side of revenues to give a visual indicator of profit or loss. In this case, the costs include wholesale cost 620, service fees 630, incentives 640, offers 650, and residual value returned 660. The revenue is shown as bids placed for the item 610. Profit 670 may be visualized as revenue minus costs. However, other costs and revenues may be included, if desired, such as shipping costs and shipping and handling revenues. The sponsor may adjust the estimated number of bidders to compare the results and see any changes in the profitability and adjust individual configurations to match the risk involved.

The customer value graph 680 may aid the sponsor in visualizing the customer perception of value obtained. As bids may cost money, the cost of bids 690 is displayed against the rewards received by the customer. The rewards may include residual value 700, incentives 710 and offers 720. Thus, a customer may perceive a greater value received than paid in, even if the residual value is not the full price of the bids purchased. Here the customer costs are exceeded and results in extra value 730. The extra value is obtained by the combination of residual value 700, incentives 710 and offers 720.

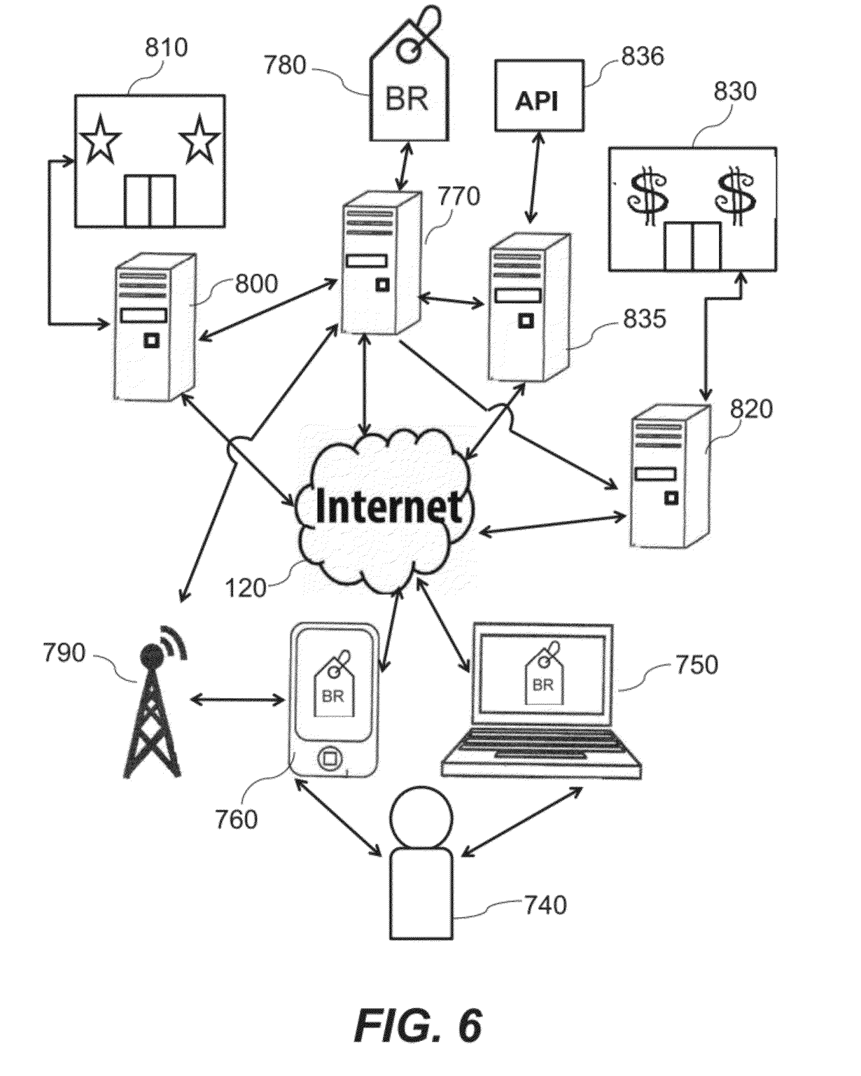

Turning now to FIG. 6, a hardware diagram of a residual value bidding system with online and offline interaction is shown. A user 740 may interact with a mobile device 760, such as a smartphone, and a computer 750. The interaction may be sent via the internet 120 or other network infrastructure such as cell towers 790. The user interaction may be received and responded to by a service server 770. The service server 770 may communicate with other support services, including a sponsor server 800, an API server 835, and a merchant server 820. Each server may be administered by the appropriate entity, such as the sponsor admin 810, service admin 780, API admin 790, and merchant admin 830. The support services may communicate with the service server 770 through the internet or through virtual or real-world direct communication, depending on the requirements.

Turning now to FIG. 7, a system overview of a residual value bidding system with online and offline interaction is shown. The service 840 may contain several systems. These systems include a bid system 850, offer system 860, residual value system 870, traffic purchase incentive system 880, bid incentive system 890, mobile redemption system 900, store interaction system including a mobile suggestion system 910, multi-system analytics 920 and API integration system 930. Each of these systems may be discussed in further detail below.

Turning now to FIG. 8, a bid system diagram of a residual value bidding system with online and offline interaction is shown. A customer 20 purchases bids 940 from the service 40. The customer 20 may use the bids 940 to bid in an auction 50. In the case of a penny auction site, each bid may add time back onto the clock 950. If the customer is eligible for a bonus, the system may provide a bonus 960 to the customer. The bonus 960 may increase with rewardable activities, such as further bids. If the customer 20 wins the auction 50, the customer may receive the residual value of the bids 95, the product 90 and offers 100. If the customer does not win, the customer may be offered to buy it now 80 using some or all of the residual value of the bids. If the customer accepts the offer, the customer may receive any remaining residual value of the bids 95, the product 90 and offers 100. If the customer declines the offer, the customer 20 may receive the stored value 95 and offers 100.

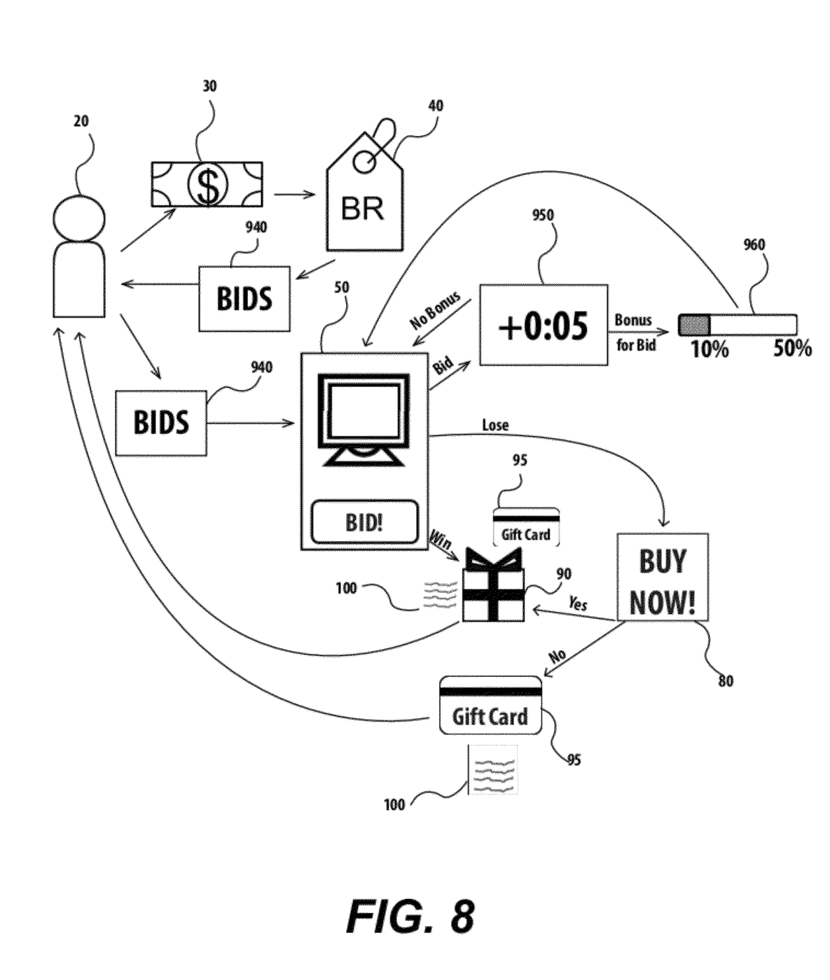

Turning now to FIG. 9, a bid system module diagram of a residual value bidding system with online and offline interaction is shown. A bid system 850 may include modules to support the bidding system. The modules may include different auction styles, such as a penny auction module 860, turbo bid module 870, traditional auction module 880. The system may include an entertainment bid module 890 which enables different bid styles such as a hammer bid or bid bomb. The modules may include account administration functionality such as sponsor administration module 900, site administration module 920 and customer administration module 930. An orders module 910 may also be found within the system to communicate orders, including winning customer information.

Different bid styles may be supported by the system. The system may allow a customer to purchase the entertainment bids and/or reward users with different bids styles. In one embodiment, a hammer bid is enabled. A hammer bid may allow a smaller reset to the clock in a penny auction style bid or a reduction in the clock in a traditional style auction. In some embodiments, a hammer bid will allow a customer to spend more bids for a smaller increase in the clock in a penny auction bid or a larger decrease in the clock in a traditional bid. A bid bomb may allow a customer to bid upon multiple auctions at once. In one embodiment, the customer bids upon all auctions displayed on the screen.

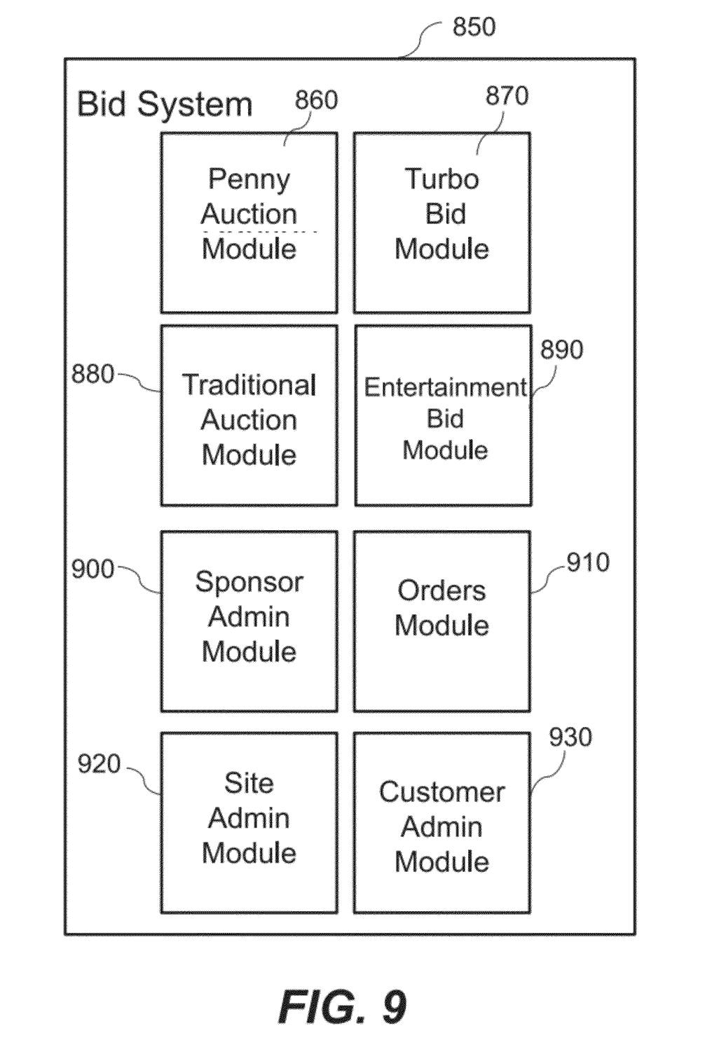

Turning to FIGS. 10 to 16, a turbo bidding system is described. While discussed in various contexts, the turbo bidding system may be integrated with the residual value bidding system with online and offline interaction.

As used herein, a turbo auction or turbo bidding refers to an auction in which the winner of the auction is the person who has placed the most number of bids during a given window of time, rather than a person making the highest bids or the last bid. It would be appreciated that the frantic nature in which a large number of bids are placed by a large number of people will appeal to a certain type of individual. For example, if a set of ten bidders place bids, 5 of which place 10 bids, 4 of which place 11 bids and one bidder places 14 bids, the bidder placing 14 bids in the allotted time would be declared the winner of the turbo auction. If each bid costs $1.00, the winner will have won the object of the auction at a cost of $14. However, $108 will have been raised by bidding alone. Thus, an auction site could offer a $90 product at a profit and the prevailing bidder receives a product worth substantially more than the cost of the bids he placed.

Turning now to FIG. 10, an overview diagram of an auction system with turbo bidding 2010 is shown. A group of bidders 2020 are notified of a planned turbo auction by an auction controller 2030. Upon start of the bidding, local actions of the group of bidders 2020 are relayed to the auction controller 2030. The auction controller 30 records the relayed information and stops the auction. The controller 2030 analyzes the relayed information and determines an auction winner from the group of bidders 2020.

For example, a group of bidders 2020 on a website served by an auction controller 2030 may be notified by the internet 2040 of an upcoming turbo auction via their computers 2050. Once the turbo auction begins, the group of bidders 2020, may be required to click their mouse 2060 as fast as they can to achieve the most clicks during the turbo auction. The computers 2050 of the group of bidders 2020 may relay the clicks to the auction controller 2030 through the internet 2040. The auction controller 2030 may store the relayed information in a database 2070. An analysis module 2080 may review the bidding information, clicks and other data and determine a winning bidder 2090.

The analysis module may include modules for fraud detection along with the standard rules for winning. For example, fraud detection may analyze the relayed messages for evidence of fraud, including timestamps, frequency and delay. Fraud may occur, for example, if a bidder uses computer generated events rather than physically clicking a mouse or providing other inputs. If fraud is detected, appropriate action may be taken, such as disqualification or removal of the questionable messages.

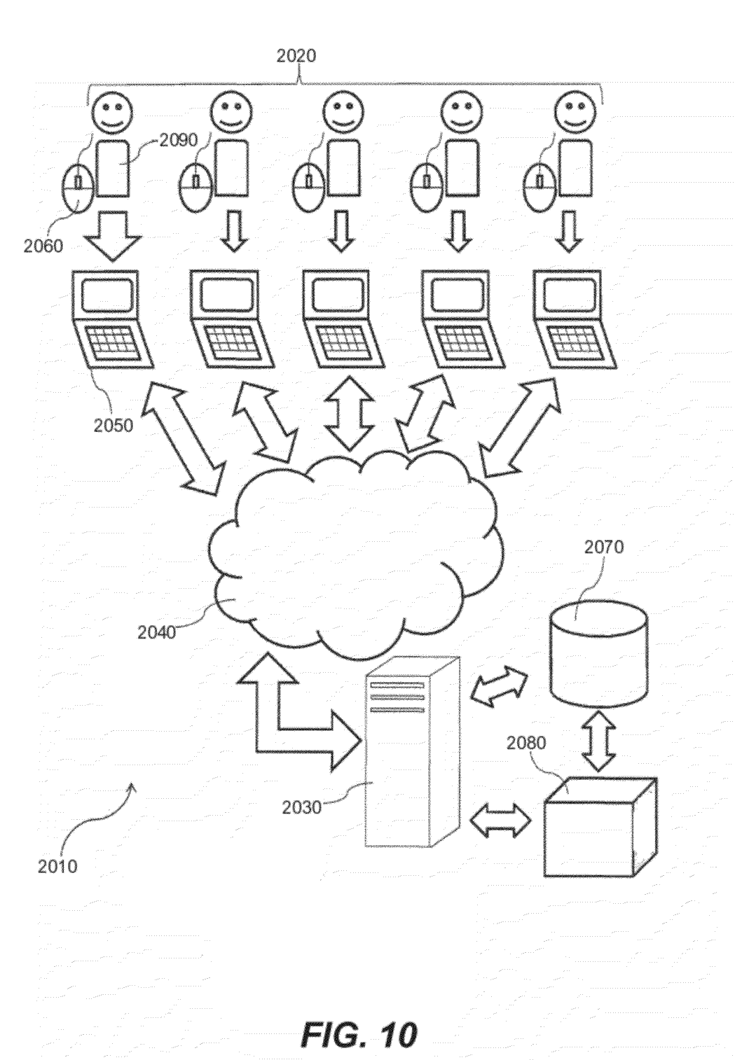

Turning now to FIG. 11, a system diagram of an auction system with turbo bidding 2010 is shown. A user system 2100 may communicate with a server system 2110 to distribute information relating to turbo bids.

The user system may have a content interface 2120, interactive interface 2130, hardware interface 2140, rendering engine 2150 and storage 2160. The interfaces may serve to communicate information externally, which may include communication to hardware, software, systems, and other external computing or information sources. An engine may use information to make decisions about system action, which may include retrieving and storing information, processing information and providing communication to the interfaces. Storage 2160 may be used to store information from the interfaces or engines until needed.

The interfaces may communicate information externally. The content interface 2120 may receive initial information to prepare a bidding environment. For example, the content interface 2120 may be an HTML interface in a web browser. The interactive interface may provide messaging services to the server system 2110 to update the bidding environment. For example, the interactive interface may be DHTML and/or Ajax support within the web browser. The hardware interface 2140 may provide support for communication with computer hardware and/or peripherals. For example, the hardware interface may include the operating system, drivers, configuration, firmware and software support. This may include such hardware as a mouse 2170 or keyboard.

The rendering engine 2150 may provide the support to convert information received over the interfaces into one or more images for display to a user, process information received and send information back over the interfaces. For example, the rendering engine may be a web browser with a window showing images to a user.

Storage 2160 may be used to save information that has occurred or will be needed. For example, storage may be used to cache a past history of bids. Similarly, storage may be used to pre-load pictures that may be used for the next bid. As the turbo bids are a fast event, network traffic related to the turbo bid may be reduced by preloading and/or caching information.

Turning now to the server system 2110, it too may have interfaces, engines and storage. The interfaces may communicate with clients and/or support services. The engines may make decisions about the auction and system. The storage may be used to track bidding and system information for analysis.

Client interfaces may provide the bidding experience to the user. Similar to the user system interfaces discussed before, the content service interface 2180 may prepare the bidding environment and the user interaction interface 2190 may manage the dynamic interaction with the bidding environment. While only one user system is shown, the client interfaces may support more than one user, as is common in bidding environments. In some cases, it may be useful to have more than one instance of the interface serving multiple clients.

External support interfaces may offload system tasks, and/or provide critical services. A financial interface 2200 may allow interfacing with external financial systems, including payment and credit card systems 2205. A support interface 2210 may allow external systems to connect to the auction system with turbo bidding 2010. This support interface may offload system tasks, such as backups, externalize internal systems, such as database support and/or cross site logins 2220, or provide other needed external services.

The engines may enable the system to make decisions and control the flow of information to storage and interfaces. A turbo bid engine 2230 may prepare, control and monitor the turbo bidding process and information. For example, the turbo bid engine may examine bid messages received from the user system and associate bids with a bidder in storage. The turbo bid engine 2230 may also examine the information in server storage 240 and from the interfaces for fraud. The system engine 2250 may manage system calls, such as configurations and logins.

The storage may contain current and historical information. Current information may include logins, system configuration, payment and address information. Historical information may include bidding information, purchases, site usage, and analytics.

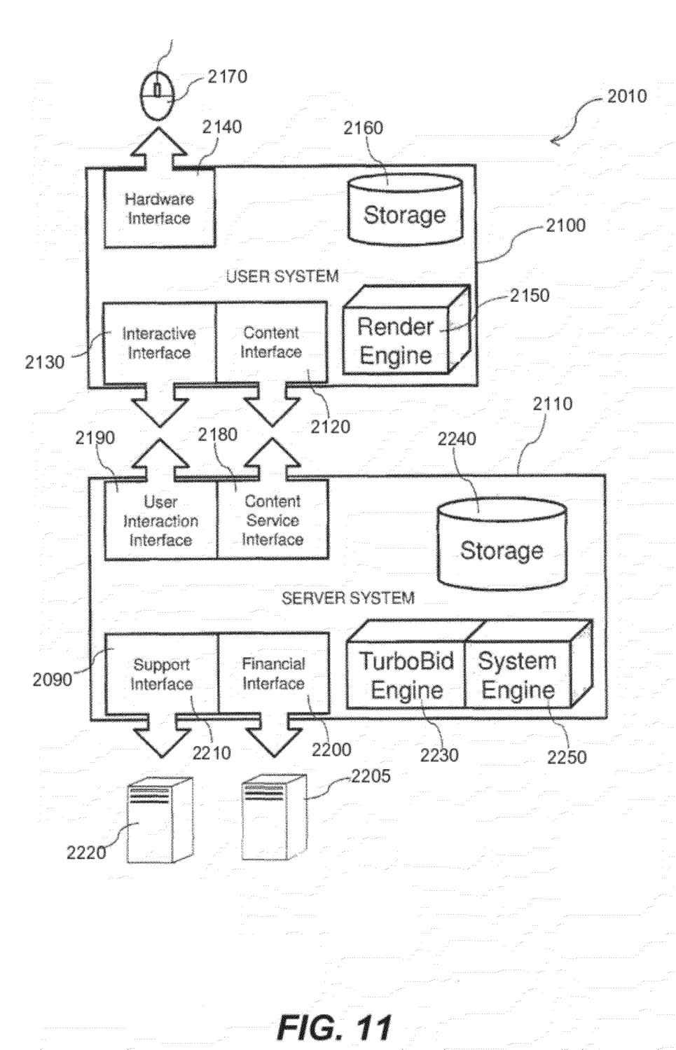

Turning now to FIG. 12, a diagram of modules contained within a turbo bidding engine is shown. The bid engine 2230 may contain modules that support the turbo bidding process. These modules may be built into the bid engine or plug-ins that add functionality to the bid engine. The modules may include a messaging module 2260, content module 2270, bid detection module 2280, fraud detection module 2290, bid analysis module 300 and person counting module 2310.

A messaging module 2260 may facilitate the communication between the server system 2110 and user systems 2100. For example, the messaging module may decide the number and content of messages that may be reasonably sent to bidders. Thus, the messaging system may send periodic updates on the bidding during the turbo bidding process. As it may be unfeasible (and potentially unwise to give all information), the periodic updates may only contain cumulative or last information, such as the current price and current high bidder. Bidders with slow connections may also get less periodic updates.

A content module 2270 may moderate the availability of content for users. For example, it may be prudent to prevent users from discovering upcoming items and seeing past items. The content module 2270 may make available pictures and descriptions of items during the appropriate periods and remove their availability when their lifecycle is complete. The content module may also allow the pre-caching of pictures and information for use during turbo bids. For example, the content module may make the content available in a hidden frame, such that the content is already on the users' computer when the turbo bidding process is initialized.

A bid detection module 2280 may evaluate the incoming bids and enforce rules of the bidding process. In a bidding system, it may be important to ensure that bidding rules are impartially performed and followed. On the internet, this may add additional complexity because of routing delays, dropped packets and/or other communication delays and/or blockages. In some cases, it may be desirable to only count bids that arrive with a timestamp before the server's cutoff time. In other cases, it may be more desirable to use a prediction algorithm to predict if a bid should have arrived on time based on the past bids. Thus, if the bid arrived after the cutoff, but was likely to come in before the cutoff, it may be given the benefit of the doubt.

A fraud detection module 2290 may analyze incoming bids and/or messages and determine a likelihood of fraud. For example, if a bidder showed a consistently timed mouse press that was just higher than other bidders, it may be marked as suspect. If it happens over several auctions, the account may be marked as fraudulent. Similarly, a bidder who starts at or too near the start time may be marked as fraudulent. In some cases, the fraud detection may need to combine metrics before it can identify fraud, such as the consistently timed mouse with an unreasonable start time.

A bid analysis module 2300 may process bids and/or messages while store the results for later use, including fraud and winning bids. The bid analysis module may process incoming bid messages, which may include time-stamping bid arrivals and associating the bids with an account.

A person counting module 2310 may be used to determine the number of people currently on the website. This may include current bidders, who are actively bidding on the site. It may also include lurkers, or people who are logged into the site and/or viewing pages, but not bidding. The person counting module may also be responsible for estimating the number of people who would likely be available for a turbo auction. This would allow the turbo bid engine to determine to place a new turbo auction, delay turbo auctions, or increase the frequency of turbo auctions.

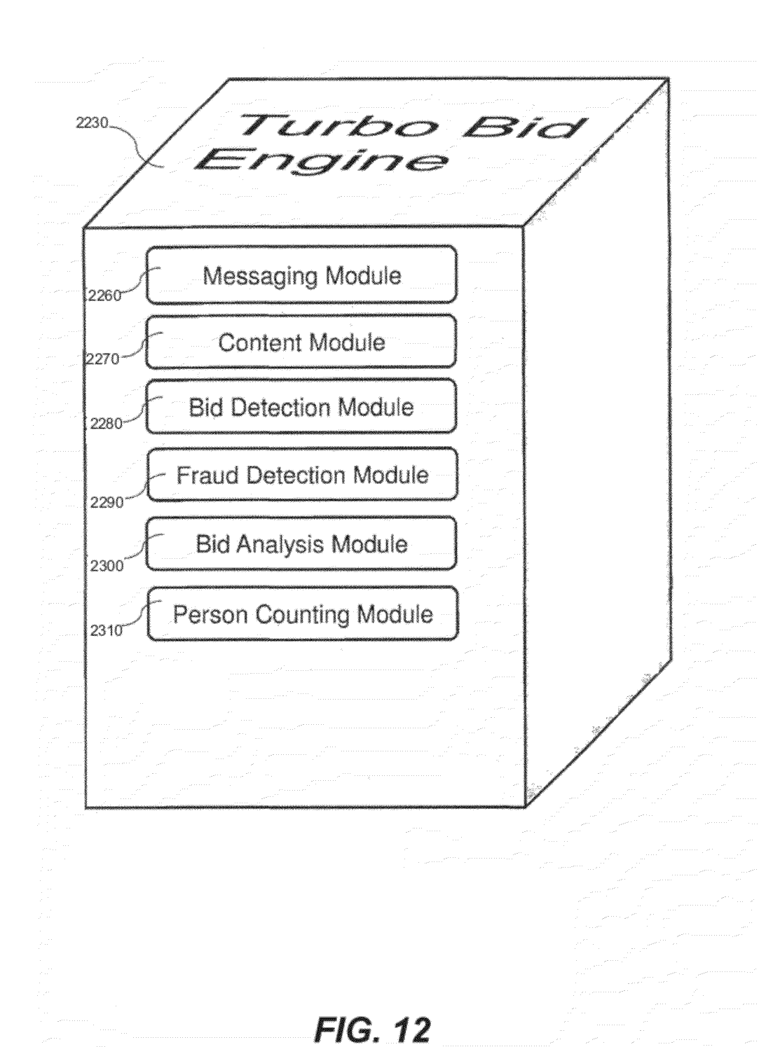

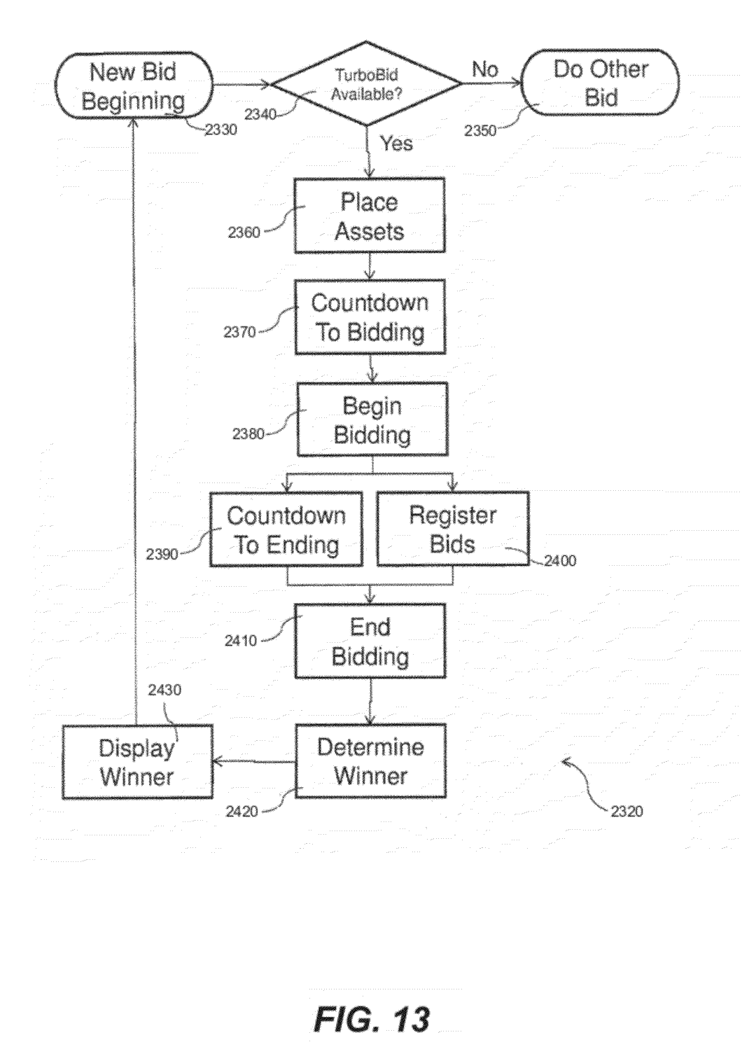

In discussing FIGS. 13 and 14, it should be recognized that exemplary processes are shown. Steps may be accomplished in parallel, out of order, subdivided and combined. The steps may be accomplished on the same machine, on different machines, through one program, or through programs interacting.

Turning now to FIG. 13, a flowchart of an auction system with turbo bidding process 320 is shown. When a new item is available for bid 2330, the system may check to see if a turbo bid is available 340. If no turbo bid is available 2340, the system may choose to do another bidding type 350, such as a standard penny auction. If a turbo bid is available 340, the system may place the bidding information and assets live to bidders 2360 and then countdown to bidding 2370. When the bidding begins 2380, a timer may be started to countdown to the ending 390 and bids may be registered for each action performed 2400. At the finish of or shortly after the countdown finishes, the bidding may end 2410. The system may analyze the results and determine a winner of the turbo bid 2420. The winner may be displayed 430, if desired, and a new item may be available for bidding 2330.

Turning now to FIG. 14, a flowchart of a turbo bidding engine is shown. When a new bid is available to begin 2440, the system may check to see if a turbo bid is available 2450. If not, another bidding type may be used 2460. If so, the bidding assets, such as item pictures and icons, may be cached 2470 on the server and preloaded 480 on the client. A messaging system may be started 2490 to enable the communication between server and client for the turbo bid. Once the server is satisfied that enough clients have adequately prepared, the turbo bid item may be displayed 2500. The countdown message may be sent 2510 followed by the bidding start message 2520. Once bidding has begun, the server may register bids 2530, send current auction status 2550 (including periodic updates to current winner, time remaining, and number of clicks) and countdown 2540 to the end message 2550. The system may determine the winner 2570 and then display the winner's name 2580 in association with the auction. The system may then return to the new bid beginning step 2440.

A turbo bid may become available through several different decision processes. In one embodiment, a turbo bid is a timed event with turbo bids dispersed throughout a basic time period plus a random interval. In another embodiment, a turbo bid is enabled when there are enough unique visitors detected on the website. In another embodiment, a turbo bid is enabled when enough bidders are detected, such that a turbo bid would likely be a successful return on investment. In another embodiment, the system analyses the past bidding history of bidders on the site and determines a likely outcome of a turbo bid. If the likely outcome of the turbo auction is a positive return on investment or exceeds a threshold, a turbo auction may become enabled.

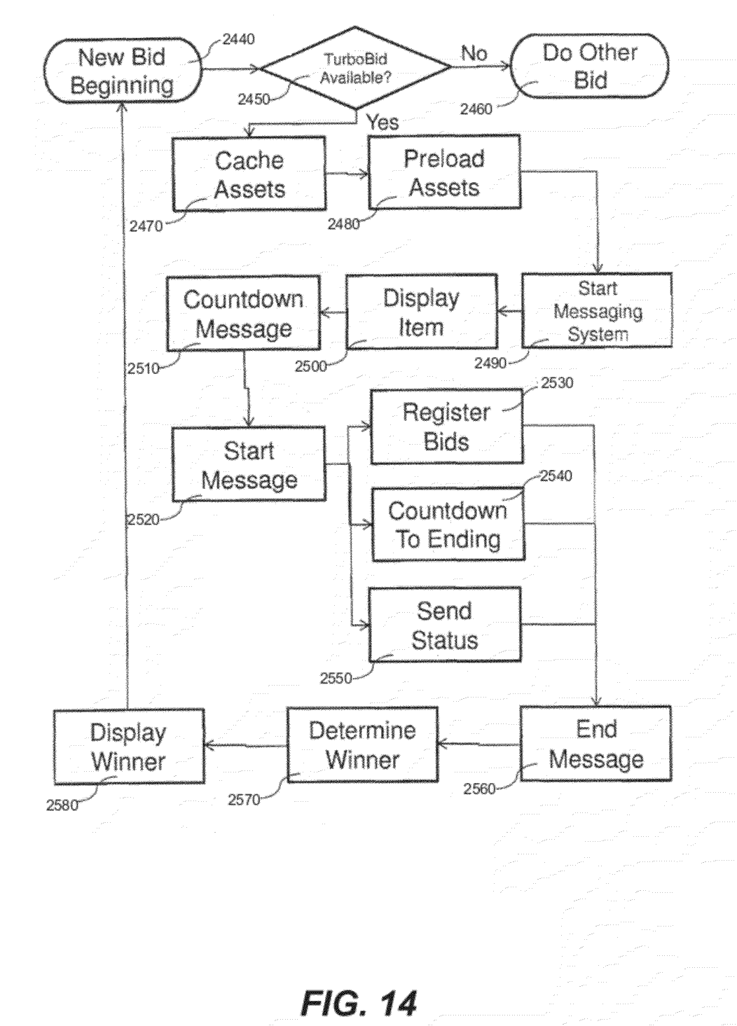

These embodiments may also be combined. For example, a turbo bid may be a timed event that may be triggered earlier if enough potential bidders are detected. In another embodiment, the random interval or basic time period may be determined by a bidder analysis as described in the above paragraph. Further discussion of the detection process may be found in association with FIG. 15.

Turning now to FIG. 15, a flowchart of person counting module of a turbo bidding engine is shown. The system wishes to determine if a turbo bid is available 2590. The person counting module 2600, then starts the people detection routine 2610. The system may process the number of people logged in and currently viewing pages 2620, including lurkers 2630 (those viewing pages, but not bidding). Recent bids may also be reviewed 2640 for more information on active bidders to count 2650. The lurkers and active bidders may be added 2660 and further analyzed, such as by bidding habits, to determine if there is enough traffic to support a turbo bid 2670. If not, another bid type may be started 2680. If so, a turbo bid may be started 2690.

In one embodiment a bidder analysis is performed by examining the number of logged in users. An individual analysis may include determining if users have joined in a turbo bid before. If so, an average (or conservative estimate) number of clicks may be counted for that user. This individual analysis may be repeated for the logged in users. If a user has not joined in a turbo auction, a smaller or no number of clicks may be assigned, depending on past opportunities.

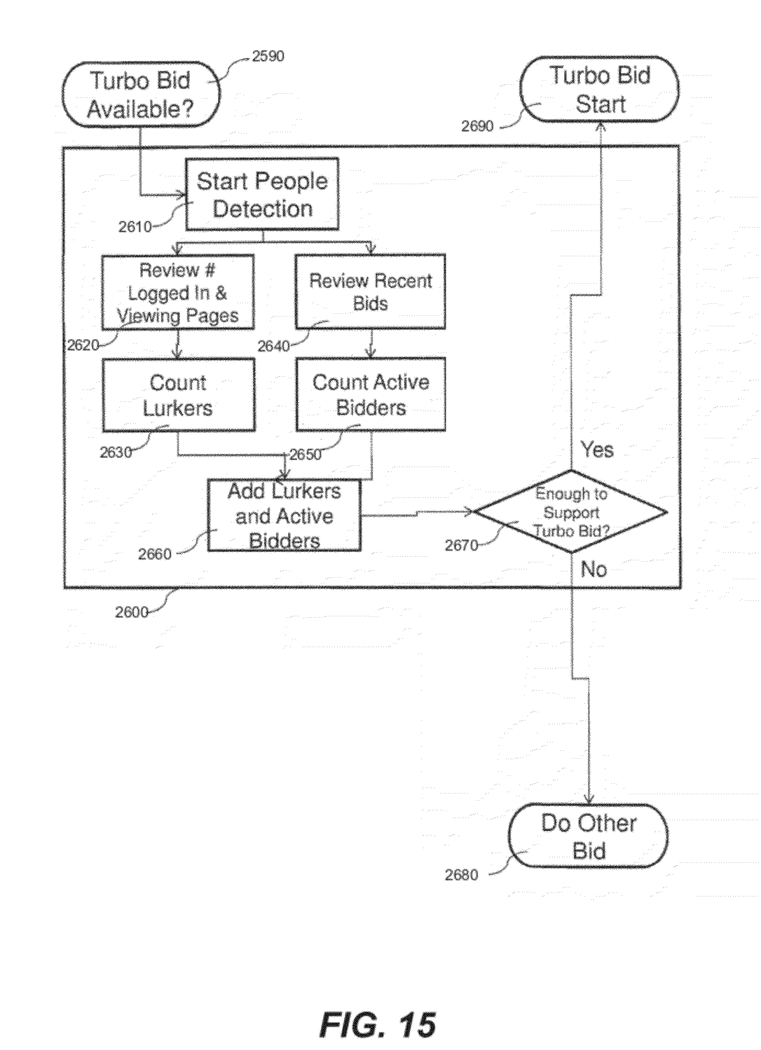

Turning now to FIG. 16, a screenshot of a customer interface 2700 to the turbo bidding system is shown. The description of the item 2710 may include retail pricing, characteristics and the name. The customer interface 2700 may also include a picture 2720 or other multi-media. The customer interface may also include a turbo bid button 2730, shown in its active state. A bidder would click on this turbo bid button 2730 until the auction closes. In one embodiment, a final countdown is overlaid upon the picture 2720 or multi-media.

The customer interface may be sent to different devices. The customer interface may include mobile devices, PC's, laptops, netbooks, internet devices, cell phones or other computing devices that may be capable of networking.

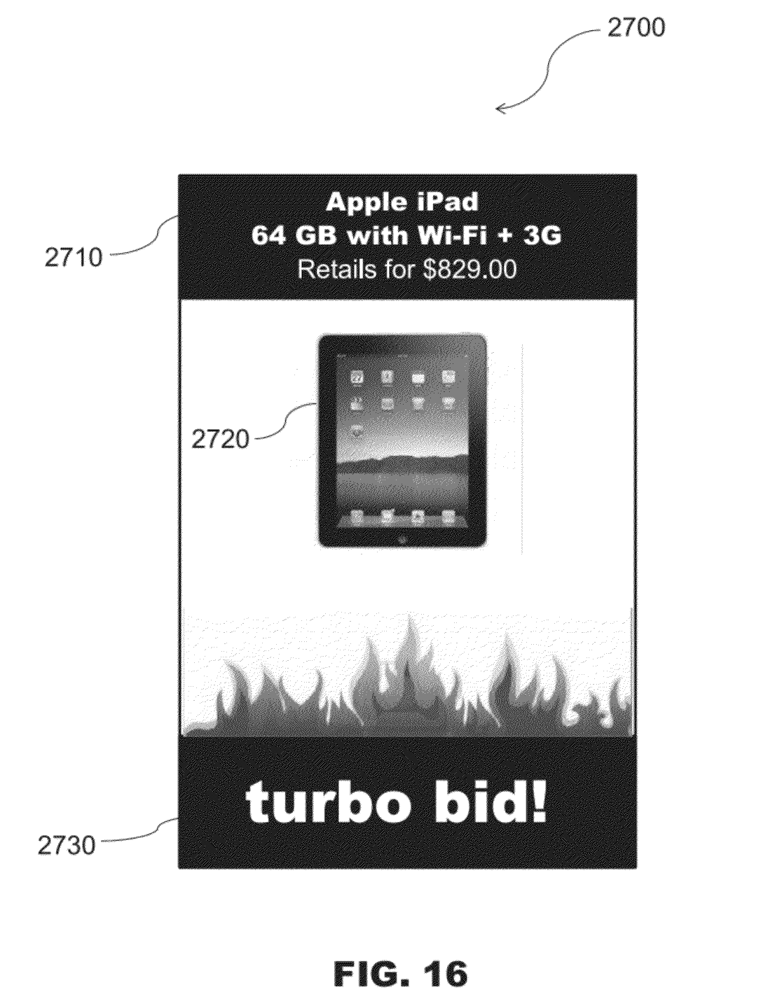

Turning now to FIG. 17, a diagram of the offer system of a residual value bidding system with online and offline interaction is shown. A customer may bid on an auction 50 until the customer wins or loses. If the customer wins, they may receive the product along with any residual value of the bids 870. If the customer loses, the system may calculate an offer 2800 to buy the product now. The offer may be presented to the customer 2810 as a discount to full retail price. If the customer accepts the offer, they may receive the product along with any remaining residual value of the bids 870. If the customer declines, the system may send the customer to the residual value system 870 to receive any residual value of the bids.

In one embodiment, the system calculates the discount by combining the residual value of the bids with a buy now incentive plus any accrued bonuses. The residual value of the bids may be pre-set by the sponsor of the auction. The buy now incentive may also be pre-set by the auction owner. Bonuses may include any bonus accrued during bidding as a bid incentive, earned coupons or discounts for store interaction, store gift cards or other value obtained by the customer.

By providing the user with the overall discount at the end of the auction, the user is invested in the product. If provided an opportunity to purchase at a discount, the user may be more likely to purchase the desired item, especially after an auction loss.

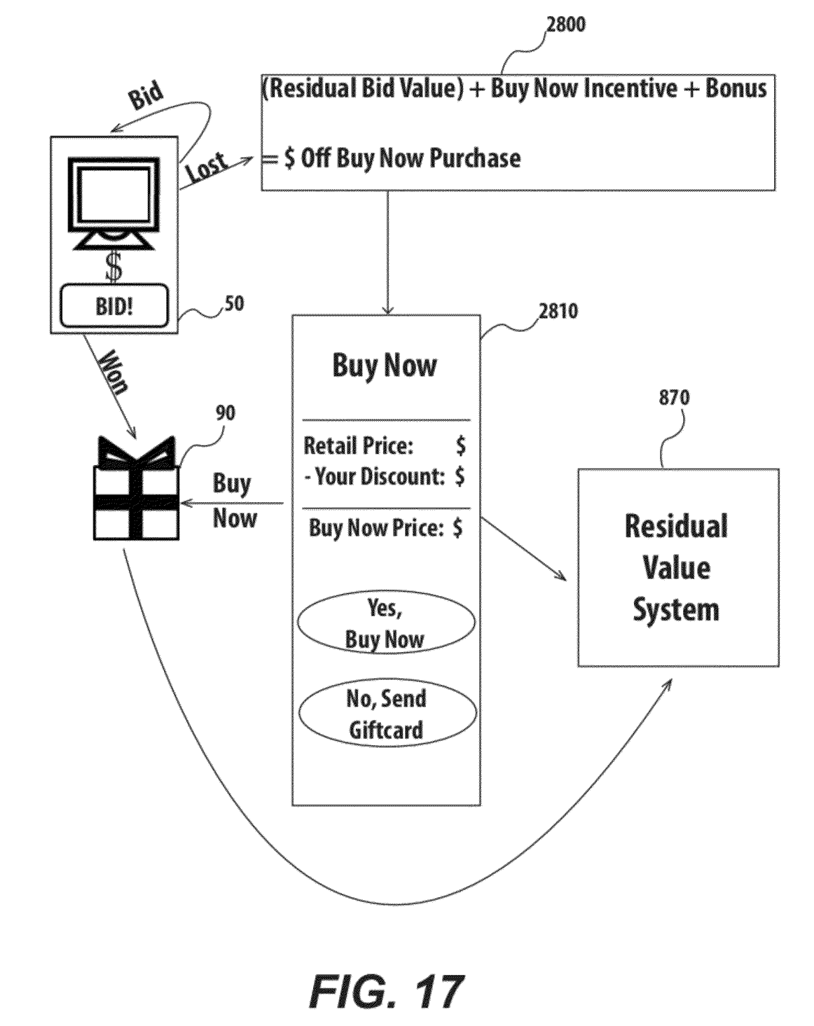

Turning now to FIGS. 18 to 30, an auction giftcard redemption system is discussed. The system may include modules that facilitate mobile redemption of stored value. The auction giftcard redemption system may integrate with the residual value bidding system with online and offline interaction.

Turning now to FIG. 18, a system connection chart of an auction giftcard redemption system 3010 is shown. A user 3020 may access an electronic auction system 3030, which may include one or more servers or other processors, from a computer 3040 or mobile device 3050. The user 3020 may set up preferences with the auction system 3030 which dictate preferred ways of receiving giftcards. The preferences may be stored in any of a variety of ways, such as being in a database or other storage medium associated with the individual user's account, or may be associated directly with a selected auction—such as a person designating how he or she would like to receive the subject matter of a winning bid upon completion of that auction.

The user 3020 may then bid on electronic giftcards available from the auction system 3030 by using an input device, such as the computer 3040 or mobile device 3030. Upon winning, a computer, software or other portion of the auction system 3030 may access a giftcard server 3035 to place the giftcard amount on a electronic giftcard, or the amount could have been preloaded on to an electronic gift card associated with the auction. Either way, the giftcard may then be automatically sent to the user or to a third person or entity according to the user's preference.

The giftcard may be electronically sent to a mobile device 3050 or computer 3040 for transfer to a mobile device 3050. This can be accomplished in a variety of mechanisms, such as by email, text message, by html code or by alternate methods of transferring a file or other electronic data which will form the electronic giftcard.

The mobile device 3050 or some other apparatus may then be used to access the giftcard to present to a store 3060. The store or a computer or processor at the store may contact the giftcard server 3035 and debit the amount spent from a file associated with the electronic giftcard. A computer or other processor at the store may also confirm that the electronic giftcard is valid prior to attempting to debit the amount associated from the electronic giftcard. The electronic giftcard server 3035 may communicate with the auction system 3030 such that the user's mobile device 3050 and/or computer 3040 access may be updated with the current amount left on the giftcard. This may include visually displaying the amount left on the giftcard so that the user is aware of the remaining balance.

The mobile device 3050 may be a useful platform, as it may be unique to the user. In the case of a phone, the system may trust the phone number, as the phone number is unique to the user. In other embodiments, other data may be used to double check the validity of the data, including data signing, MAC address, ESN, MEID, and IMEI. Thus, the recipient of the electronic giftcard may be required to provide a code or other information to verify safe receipt of the electronic giftcard and/or to make the electronic giftcard useable.

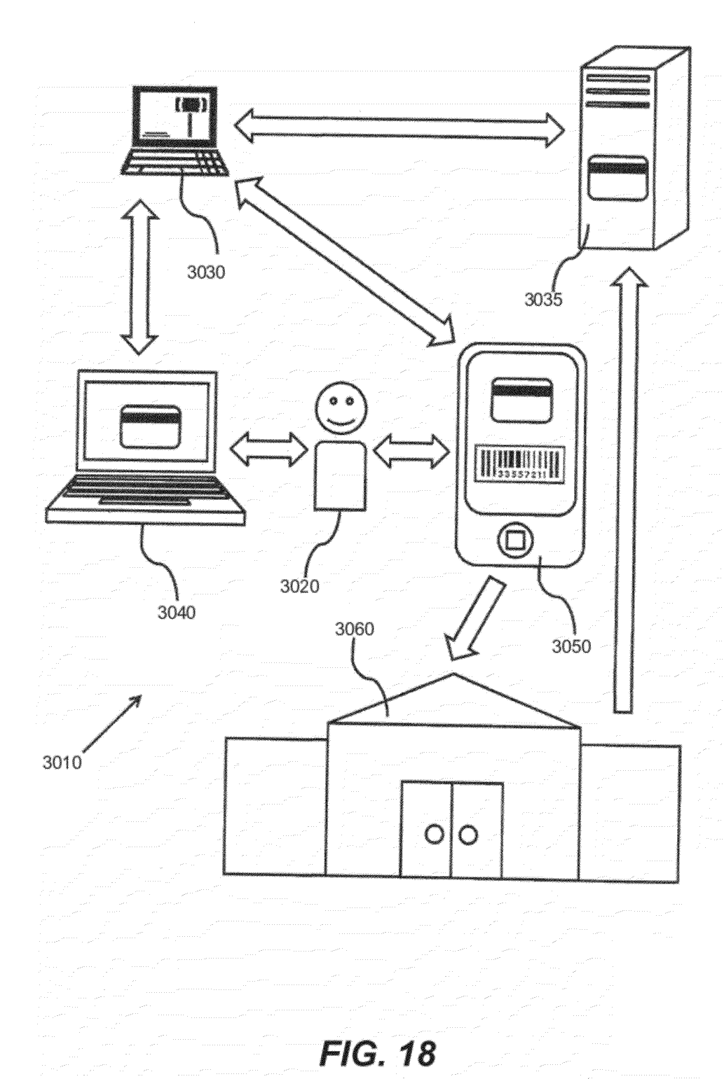

Turning now to FIG. 19, a giftcard redemption chart is shown. Once the auction has been won (and the giftcard server has authorized a giftcard if required) the gift card may be sent in accordance with a customer's preference. For example a person may desire that all of their electronic their smartphone. The electronic giftcard may be sent via giftcard information 3070, using any of a variety of protocols, to a mobile device 3050, a print at home service 80 for a paper printout 3085 or via mail 3090 with a tangible card 3100.

In the case of a mobile device 3050, the giftcard information 3070 may be suited to the mobile device 3050 capabilities. In the case of a smartphone, the auction system 3030 may send a data package 3110 (such as signed data, that may be encrypted) through a wireless data network 3120 to an app on the mobile device 3050. In the case of an email capable mobile device 3050, an email 3130 may be sent. Some users may prefer to receive a barcode picture 3150 via a multimedia service such as MMS, that may be scanned at the retailer. For basic phones, a text message 3160 with the giftcard number may be sent.

In the case of the package, MMS or email, a picture of a barcode may be shown on the mobile device 3050. The barcode may be scanned at the retailer, as a normal giftcard is scanned. The transaction, thus may be made fairly instantaneous. Furthermore, the cost of delivery is significantly reduced over physical cards, as there is no postage, envelope or shipping processing. In fact, the system may be largely automated. The potential for lost, stolen or forgotten cards may also be reduced.

In the case of online stores or a basic phone, the system may provide a number which may be used to represent the giftcard. This number may be received by text message 3160, inside the picture sent by MMS, within the email or available in the smartphone application.

By pre-selecting the delivery method of the giftcard, the user may quickly receive the giftcard while still enjoy the win at auction. This may further fuel the user's desire to bid in future auctions, as they have quickly received their winnings and are able to increase the pleasure associated with winning the auction by adding the pleasure of instantly using the gift card to purchase a desired item.

In one embodiment, the bidding software is integrated with the delivery application. Thus, the user can quickly receive the winning giftcard in electronic format in the same application from which the bid was won. Furthermore, the bidding application may show current auction items when started. This may encourage future bids, as the customer will see the auction items as they go to use their giftcards.

As the needs of the user change, the user may update their preferences. Thus, a user may select different delivery methods for future giftcard wins. In some cases, the user may need to have cards re-issued and/or reported as stolen. In one embodiment, the user may choose to have the giftcards re-issued because their phone was lost or stolen. If such is done, the a previously sent electronic giftcard can be immediately deactivated to prevent it from being used by others.

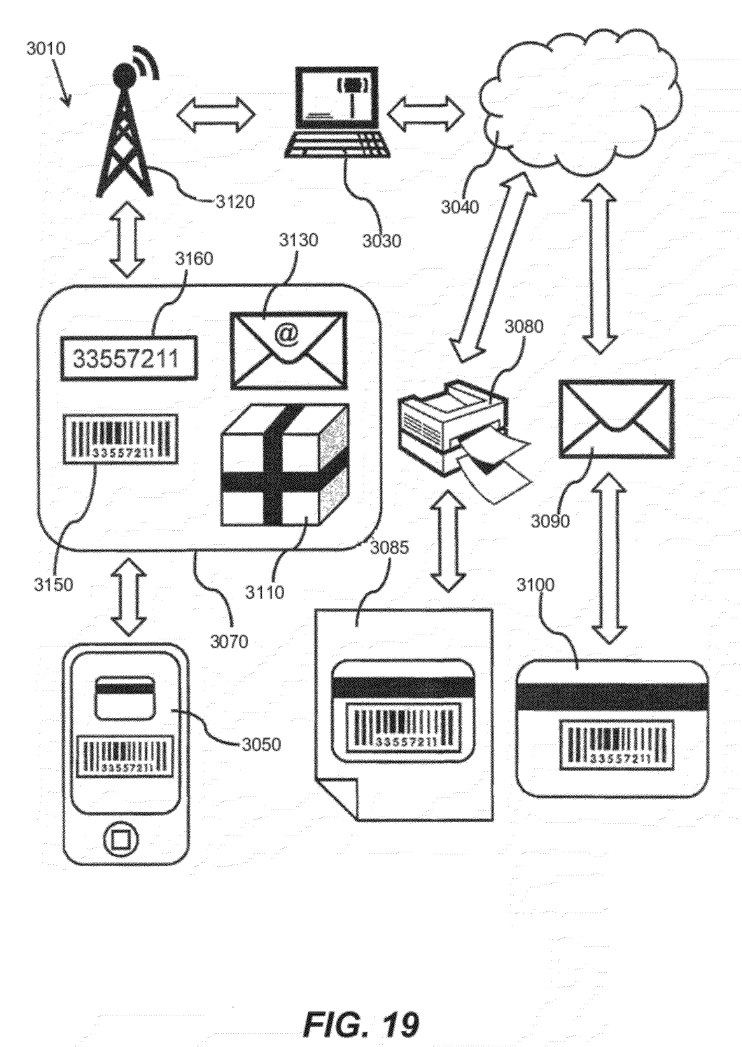

Turning now to FIG. 20, a flowchart of a giftcard purchase and delivery system 3165 is shown. An account is created for a customer 3170. The customer chooses delivery preferences of future giftcards 180. The customer may purchase a giftcard 3190. After purchase, the system may determine the customer's preferences for delivery 3200. The giftcard server may be contacted to obtain a correct balance on a giftcard 3210. The electronic giftcard information may then be sent to the customer according to the customer preferences 3220.

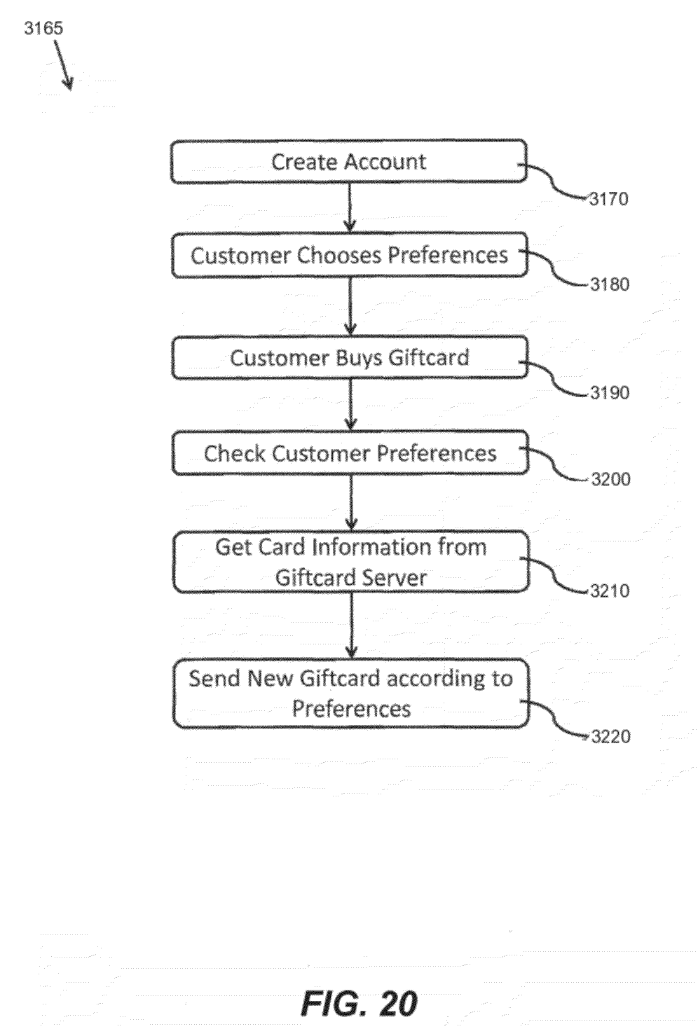

Turning now to FIG. 21, a flowchart of an auction giftcard redemption system 3225 is shown. The customer may create an account 3230. The customer then selects desired preferences, including giftcard delivery 3240. The customer wins a giftcard in an auction 3250. The system checks the customer preferences 3260. The system contacts the giftcard server and receives information from the giftcard server 3270 to create an electronic giftcard. The electronic giftcard data is sent to the customer according to the customer preferences 3280.

It should be recognized that many of the processes steps may be rearranged or processed in parallel. The steps are shown in the order shown for clarity reasons. For example the check customer preferences step 3260 may be done in parallel with the get card information from giftcard server 3270 step or in reverse order.

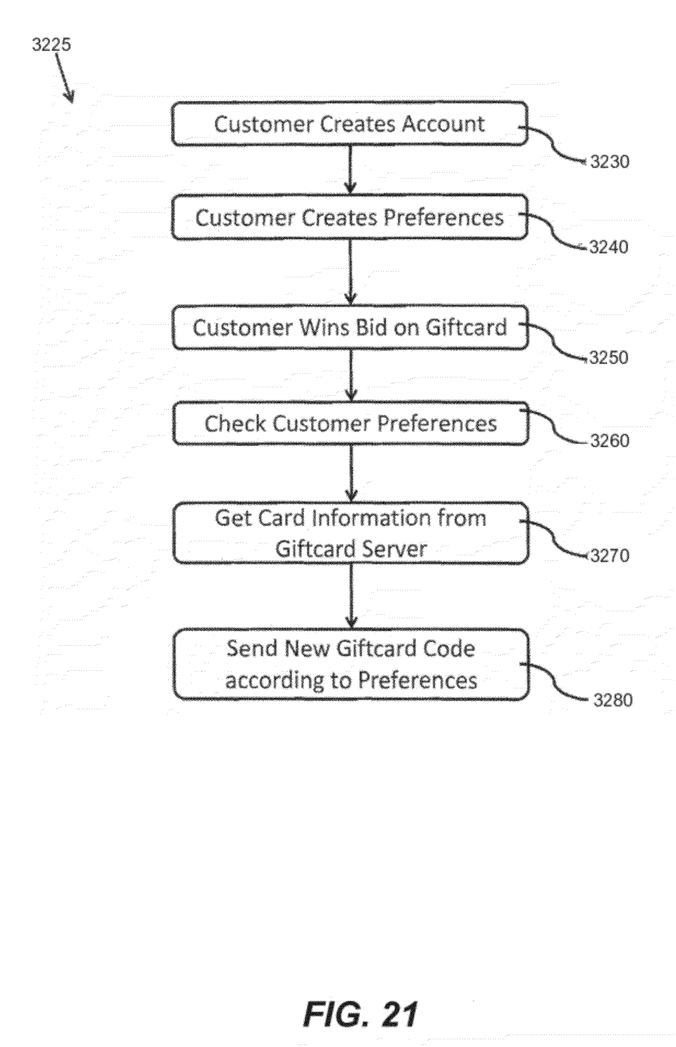

Turning now to FIG. 22, a flowchart of an auction giftcard redemption system 3285 with reloading is shown. Steps from 3230 to 3260 are repeated from FIG. 21. However, if the customer has already received a giftcard to a store 3290, the giftcard server may be contacted 3300 and the prior giftcard reloaded 3310. If not, then the giftcard server may be contacted 3320, a new giftcard created 3330 and the giftcard sent according to the customer preferences 3340.

By reloading a giftcard form an auction, the customer may be able to use up more value in the giftcard, such as a giftcard that had a $5.00 balance may not buy much at a department store and may be awkward to present and have to pay for the difference in the purchase price. By reloading the card, instead of providing a new card, the customer may be encouraged to bid more to fill up the card to a useful level. Furthermore, it reduces clutter, as the user will not have to remember how many outstanding giftcards are present for each store. It also reduces the number of individual giftcard accounts that are required from the giftcard server.

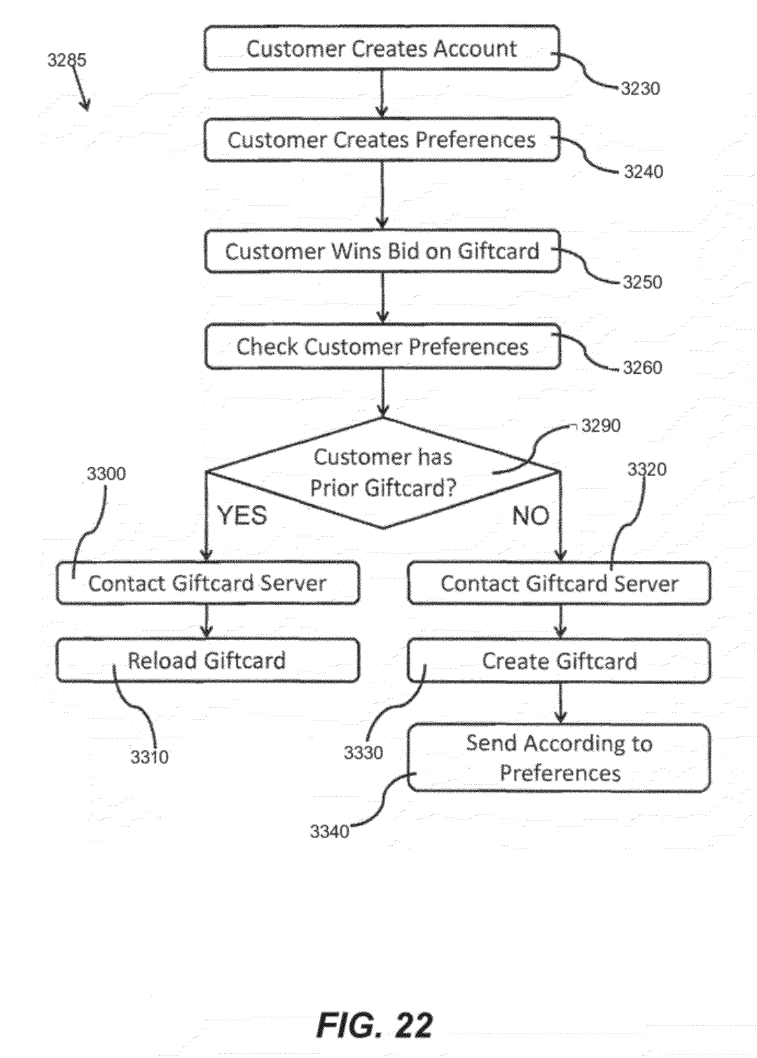

Turning now to FIGS. 23 to 30, exemplary interface screens are shown to help understand the invention. It should be recognized that individual mobile devices, computers and other processors may have their own native screens or displays and methods that affect the look and organization of the interface. However, many of the principles remain the same.

Turning now to FIG. 23, an auction delivery configuration screen 3350 is shown. The Auction delivery sight may be allow participants or remote in or may be housed on any of a variety of different types of networks (involving various computers, processors, screens, etc), including the Internet.

The user may select a delivery preference 3360 and/or a new card per win option. The delivery preference 3360 may include delivery to an app, a barcode, a text message, an email, a physical card, or requiring the system to ask upon a winning bid. The user may also select from various options that may include an option to always create a new giftcard 3370 rather than reloading previous ones. The settings may be automatically saved upon change or when a button 3380 to save the settings is clicked.

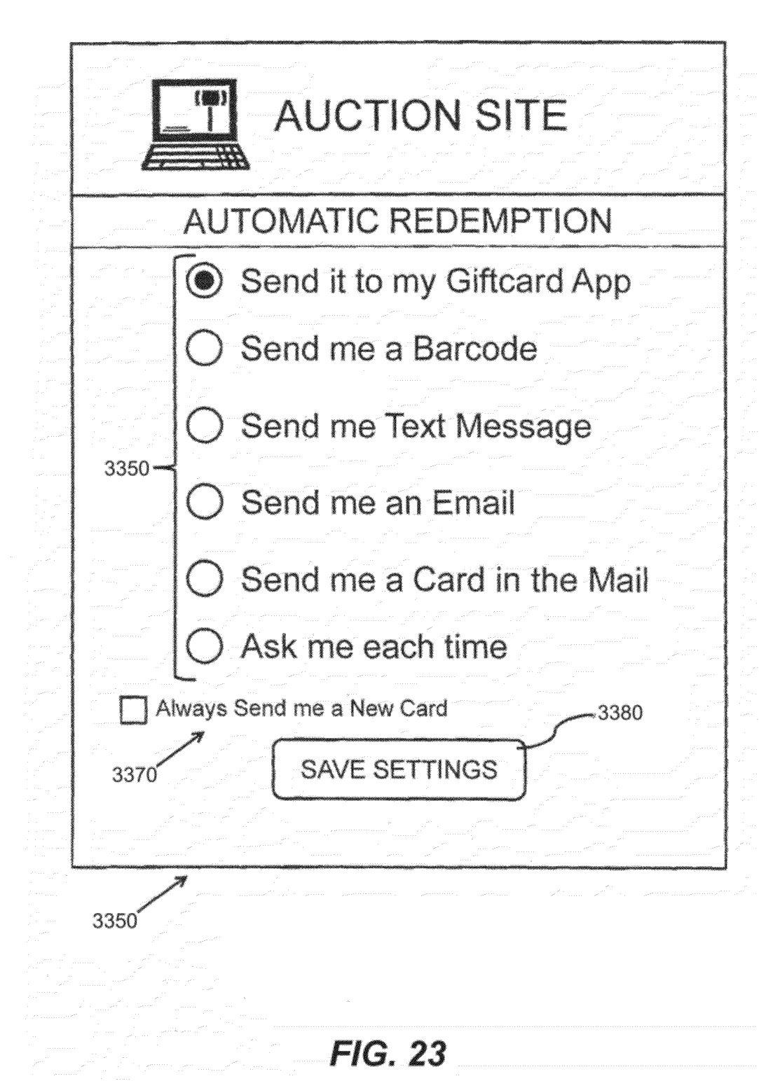

Should the user decide for an application delivery, FIG. 24 shows a giftcard selection screen 3390 of an application. The application may list each giftcard 3400 with the store name 3410 and the amount remaining 3420 on the giftcard. The application may also contain buttons to sort and/or search the giftcards 3400, including organization by name 3430 and organization by amount remaining 3440.

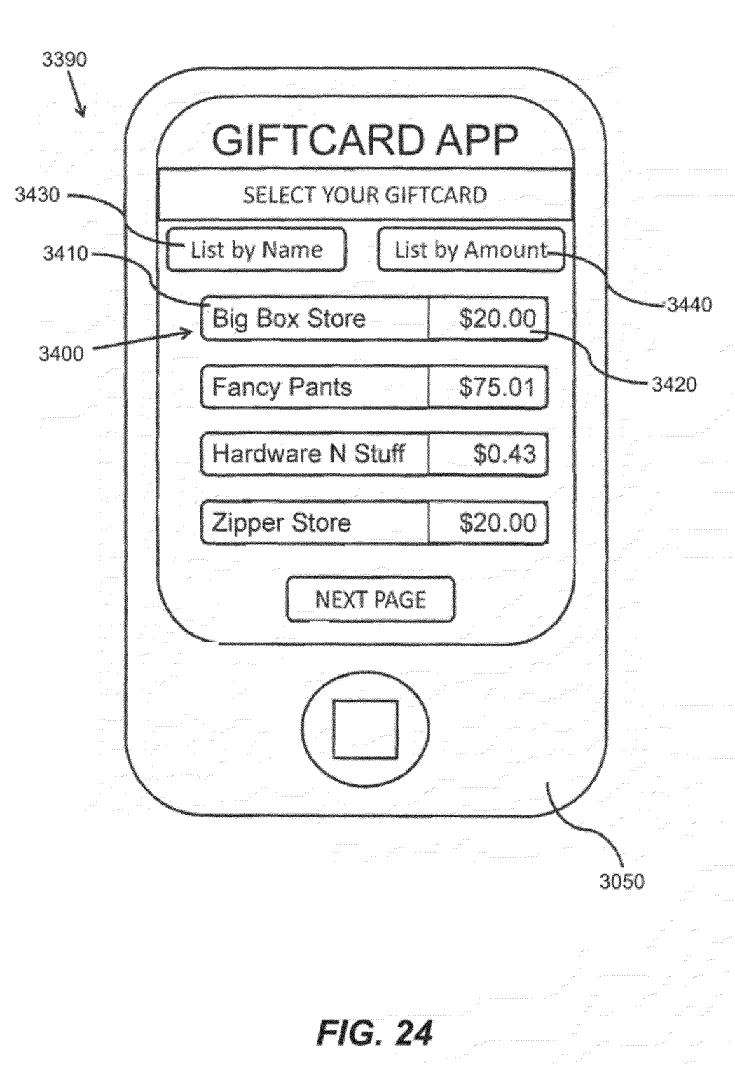

Once the user selects a giftcard, a giftcard redemption screen 3405 may be shown as in FIG. 25. The name of the store 3410 along with the amount remaining 3420 and a scannable bar code 3450. In one embodiment, the user may click on a button 3460 to add money to the giftcard.

Using this screen, a user may present the mobile device 3050 to a cashier for scanning as a giftcard payment method at a register. The scanner may read the barcode and apply the giftcard to the purchase.

In another embodiment, the mobile device may use a wireless protocol to provide payment at a terminal. For example, the mobile device may be configured to communicate with a gas pump wirelessly, such that the mobile device 3050 need only be placed near the pump. In one embodiment, the mobile device may ask for confirmation of the purchase, such that another gas pump bill is not accidentally paid.

In some embodiments, further precautions are taken. In one embodiment, a password is required to be entered before the app will show payment information. In another embodiment, a one-use barcode or card number is used for each payment, such that a person may not steal the number to be used again. Any remaining dollar value would remain in the giftcard account.

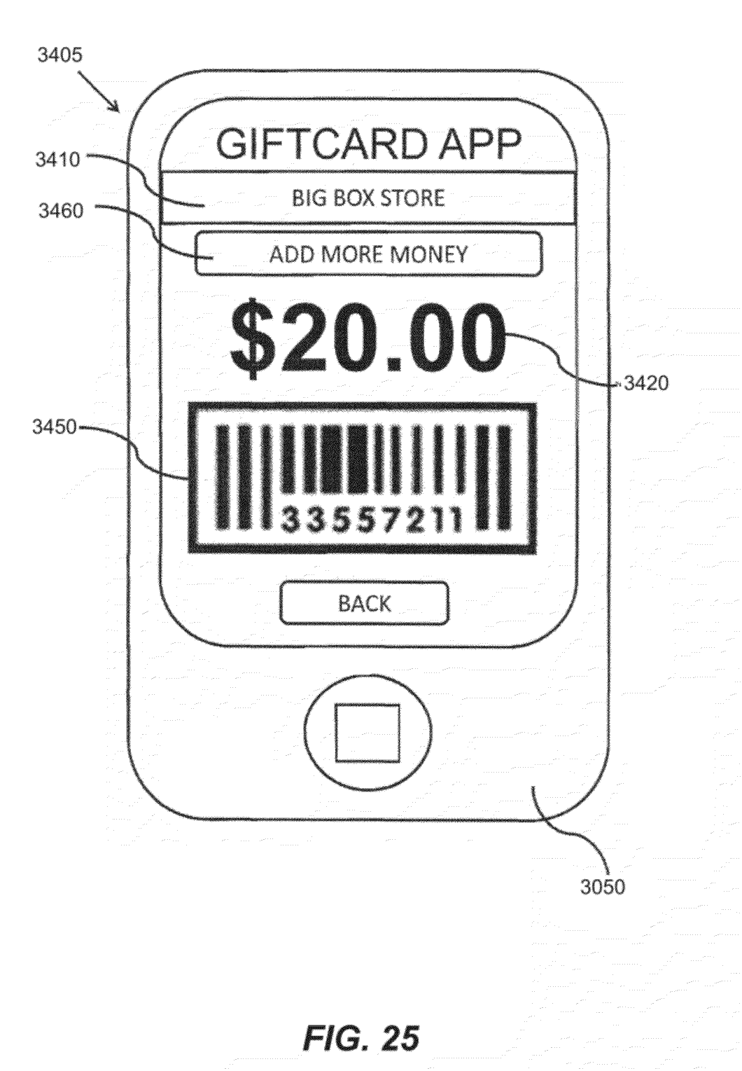

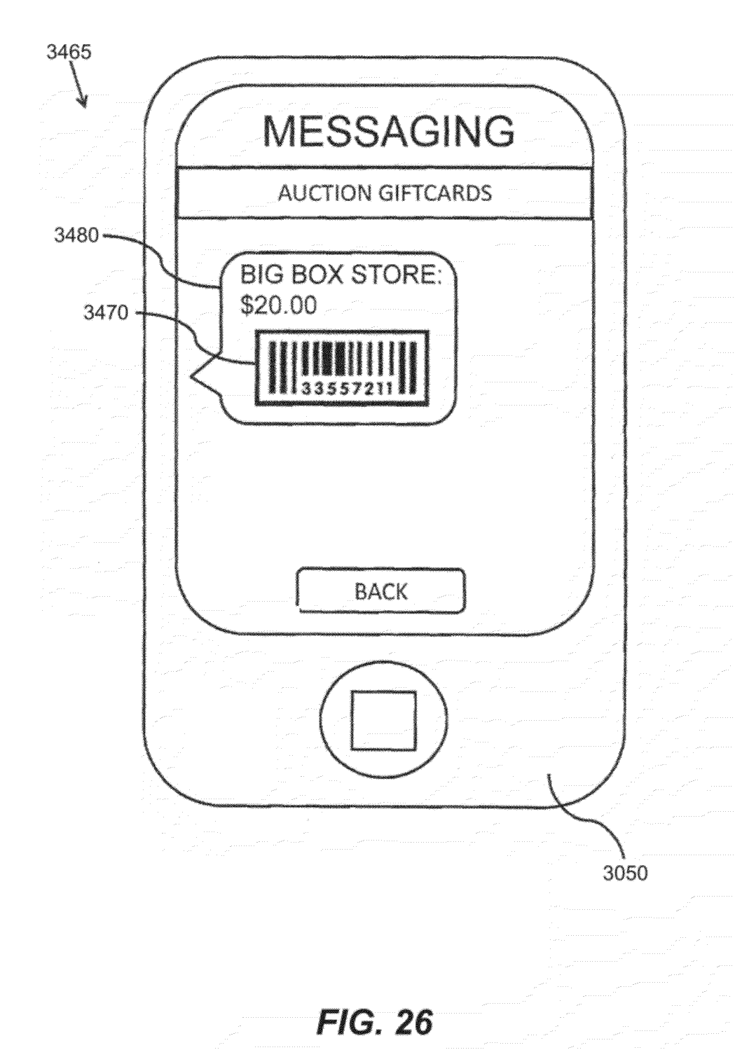

Turning now to FIGS. 26 and 27, messaging service deliveries are shown for multi-media (MMS) delivery 3465 in FIG. 9 and text messaging (SMS) delivery 3485 in FIG. 27. The auction system may also deliver through cellular messaging systems. Should the customer choose multi-media delivery of a barcode, the system may send the image of a barcode 3470, along with a message about which store and how much is on the giftcard 3480. If the user desires, they may request a status update of the amount on the giftcard sent to their mobile device with or without the barcode by logging into their account.

Similarly, if the customer chose to have a text-message delivery, the auction system may send a text message 3490 that includes the card number 3500. The card number may be input at a register or input into a giftcard payment field in an online retailer.

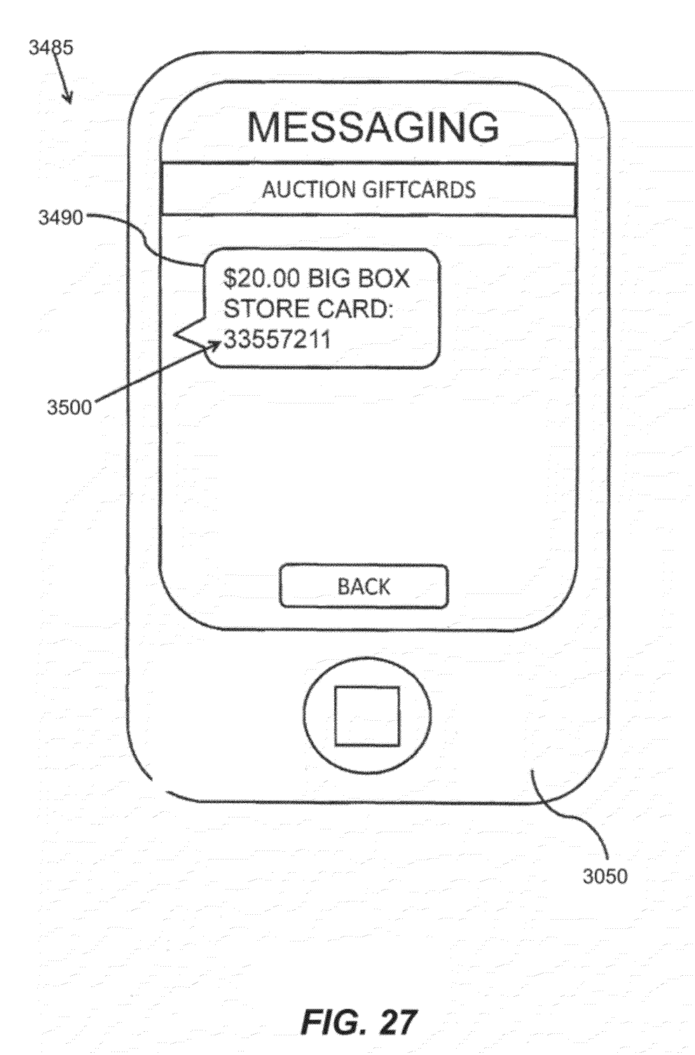

The auction system may also include a messaging system that responds to requests from an authorized phone as seen in FIGS. 28 to 30. As a user may choose to associate a mobile device with their account, the mobile device may be used to request status information or card information from the auction system. In the case of cell phones, the system can identify the incoming cell phone number and match that number with the associated account. Thus, the system may use a short code, email address or phone number to receive messages. The messages may then be decoded and an answer returned to the customer.

Turning now to FIG. 28, an interactive text message query redemption screen 3505 is shown. A customer may send the auction system a message 3510 with the name of a store. If the customer has a gift card related to that store, the system may respond with a message 3520 displaying information about the giftcard, including a confirmation of the name of the store, the amount remaining on the giftcard and the giftcard redemption number.

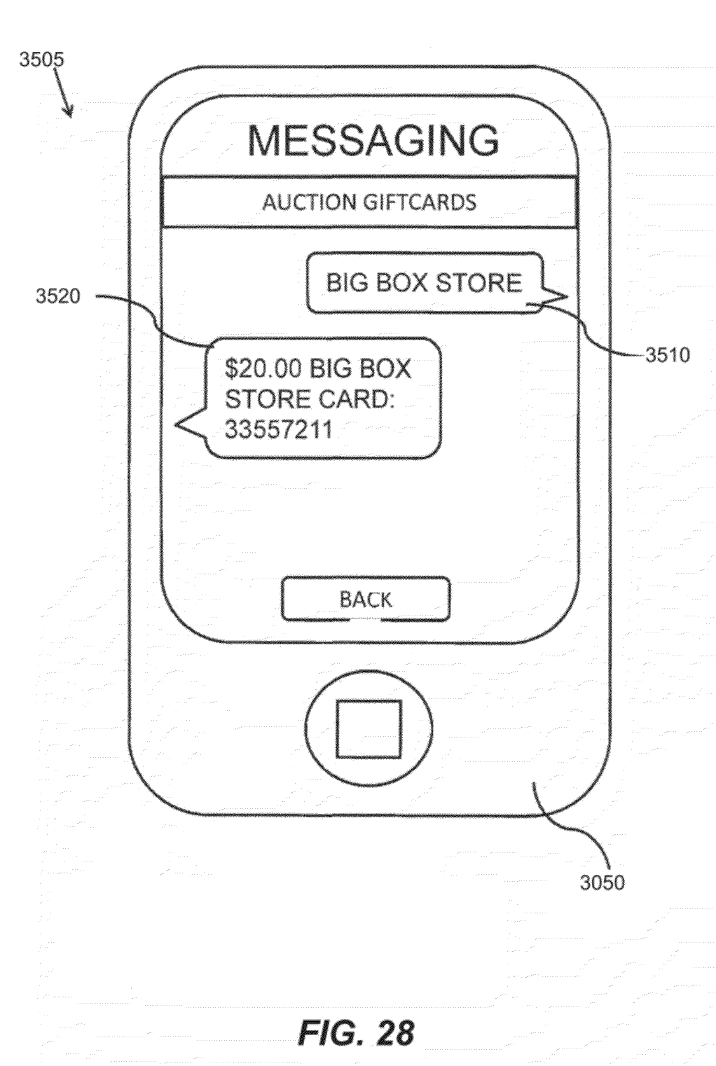

Turning now to FIG. 29 an interactive multi-media message query redemption screen 3525 is shown. Should a customer preference be set or the message 3550 contain a request for a MMS message, the auction system may return a message 3540 that may include a barcode along with the other giftcard information discussed in FIG. 28.

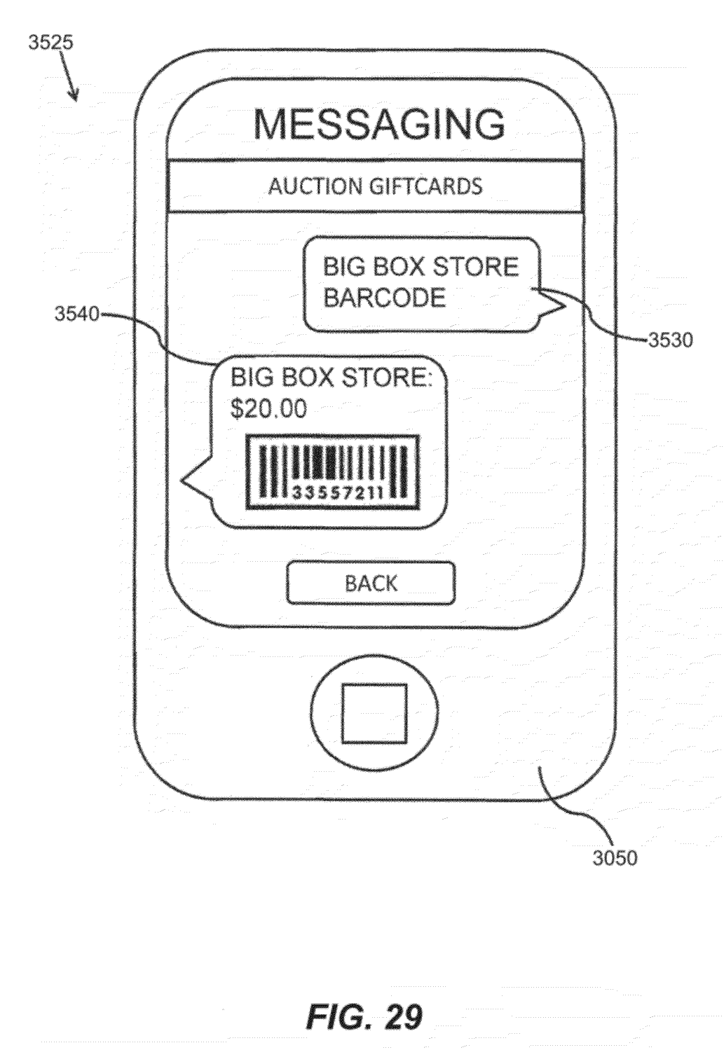

Turning now to FIG. 30, an interactive text message amount query result screen 3545 is shown. In some cases, only specific information is desired. The customer may send a message 3550 requesting only specific information. The auction system may read and respond to the request with only a confirmation and the information requested in a message 3560. In this case, the customer only wanted to know the amount left on the BIG BOX STORE giftcard. The system confirmed the request was for the BIG BOX STORE and returned a balance of $20.00.

Turning now to FIG. 31, a diagram of the traffic incentive system for offline traffic is shown. A customer may go shopping at a store 140. The customer may be detected 130 by the store, and the customer location sent to the service 40. The service 40 may retrieve information about the customer from one or more databases 3600. The information may include bid history, current gift cards and current store offers. The information may then be used by the service 40, as directed by the store, to provide a notice to the customer, which may include purchase incentives 3640. The customer 20 may review the purchase incentives and if desired purchase an item 90 using any incentives, stored value and money 30. The customer may also receive other rewards for an immediate purchase, such as promo bids 3650.

The store may detect a customer in multiple ways. In one embodiment, the customer may have a device with GPS or other location based technology. The system may send the location data to the service. The service may then use the location data to determine if the customer is within a store. In another embodiment, the customer may use near field communications to receive information from the store (such as current specials, a menu, or sale items). In another embodiment, the customer may use a kiosk to receive information from the store (such as current specials, a menu, or sale items). Once the customer interacts with the service, the system may log the location of the interaction with a timestamp. Interactions may also be incentivized, such as through promo bids or other rewards, so that the customer will desire to give up location information.

Alerts and purchase incentives may be tailored to the user based on a valuation of the customer. Frequent purchasers or other high value customers may be targeted to increase profitability and/or loyalty. New visitors may receive incentives to try products or services. Low value customers may be ignored or efforts made to provide incentives to turn them into higher value customers.

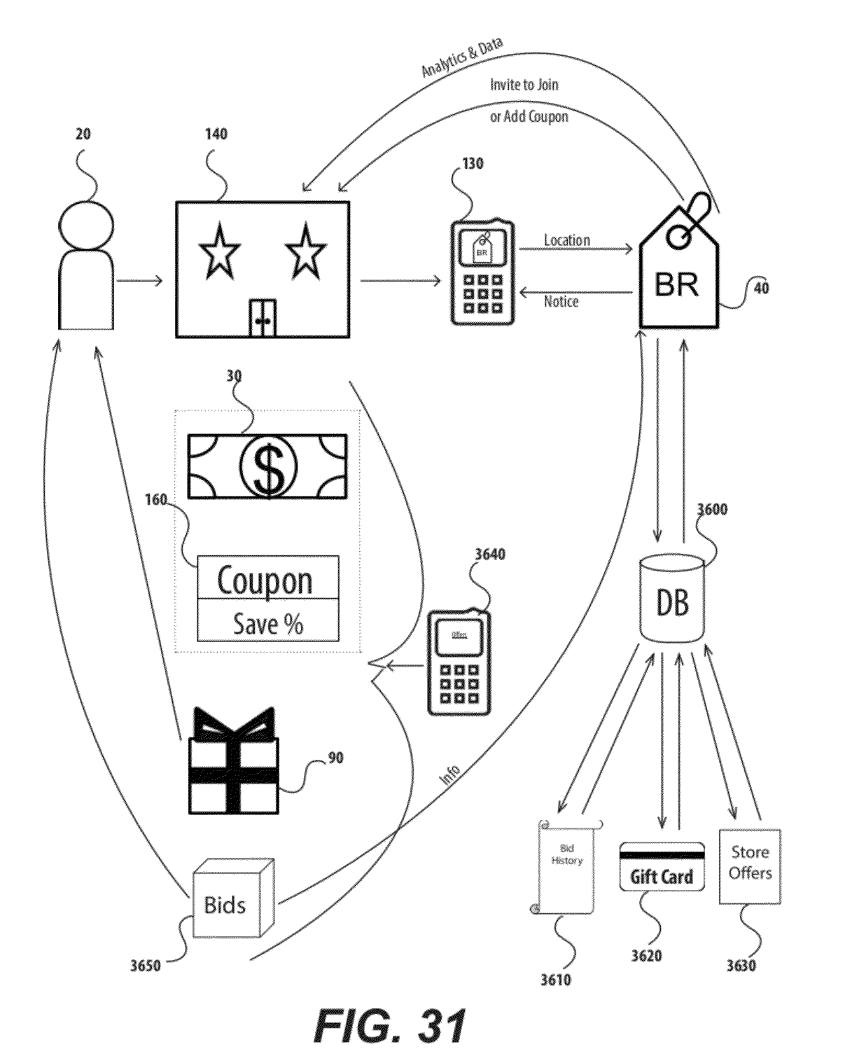

Turning now to FIG. 32, a diagram of the traffic incentive system for online traffic is shown. A customer 20 may come to the service 40 and explore the auction items. If desired, the customer may choose to receive more information about a product or service 3660. The service may then direct the customer to the website of the sponsor 140, while retaining the ability to obtain analytic information, such as through an iframe. While at the store 140, the customer may receive offers or incentives from the store 140. Eventually, the customer may choose to purchase the item 90 from the store 140. As all this interaction may be recorded, the service 40 may provide analytics about these visits and transactions to the store.

In the online environment, the service may use recommendations from friends to encourage purchases. For example, if another customer received an incentive to create a recommendation to their friends about a product, that recommendation and link to the friend may be stored. As the friend browses the service 40 and store 140 on-line, the store may use the recommendation to drive the friend to that recommended product purchase. This may be through a landing page that includes friend's recommended products or through product pages that include information about the friend's purchases and/or recommendations.

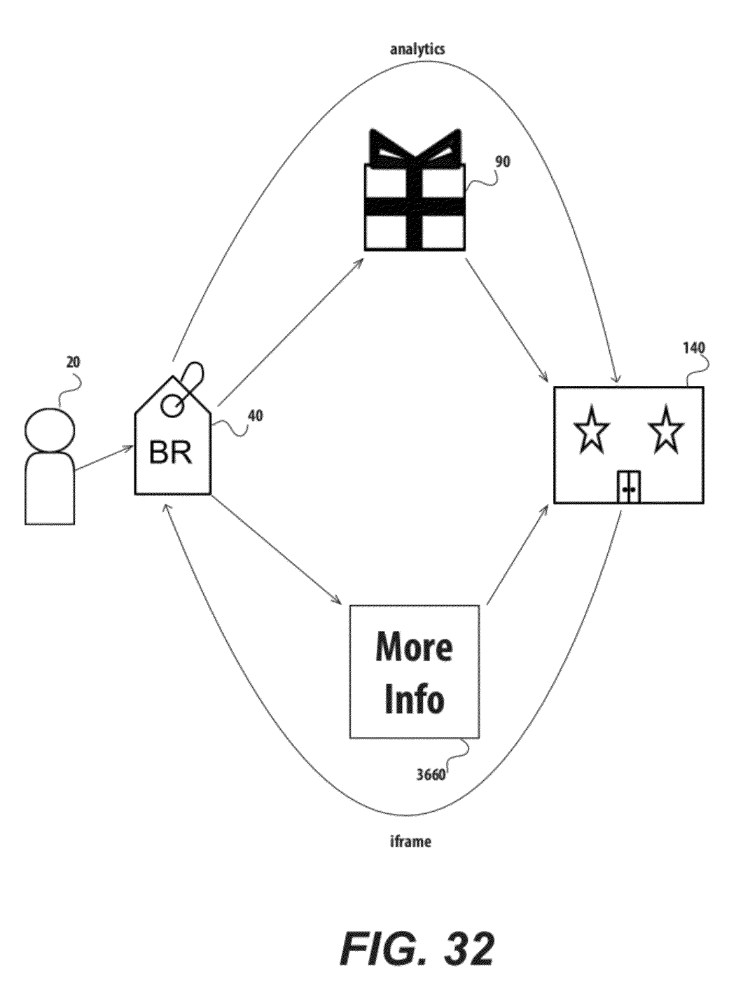

In FIGS. 33 to 40, a sponsor of an auction may return some or all of the value spent in bidding to bidders. Bidding may be encouraged by providing more rewards for bidders that use more bids. For example, in one embodiment, a sponsor may return a giftcard for the value of the bids placed on a online penny auction. Bidders may be encouraged to bid because they may receive a percentage off coupon that increases for every bid placed on an item.

The income from the bids may be divided among the auction and the sponsor. Thus, a sponsor may create a consumer buzz while maintaining the fun of an auction with a positive brand experience. Furthermore, the sponsor may ensure that the bidder's money must be spent in their store by the return of the value through giftcards. In fact, the percentage off bonus may be time limited to further encourage immediate recognition and use of the incoming money.

As both parties may be paid through the purchase of bids, the auction site may not require a cost to promote the sponsored auction. Thus, the sponsor may receive advertising and promotion for the cost of a few items to bid upon and the split of the revenue in terms of the giftcards.

Turning now to FIG. 33, a diagram of a residual value bidding system 4010 is shown. A sponsor 4020 provides items 4030A, 4030B to place up for auction 4040. A bidder 4050 purchases bids 4060 for value 4070. The bidder 4050 may bid upon the item 4030A with the purchased bids 4060. If the bidder 4050 wins the auction 4040, the bidder may receive the item 4030A after paying the winning price 4080. A portion of the proceeds 4090 may be split between the sponsor 4020 and the auction owner. The sponsor 4020 may return at least a portion of the value of the bids placed by a bidder 4050, which may be in the form of a giftcard 4110. Incentives to bid may also be used, which may include time-dated coupons 4120 that grow a percentage off purchases at the sponsor 20 as more bids are placed. The bidder 4050 may then use the value received, such as a giftcard 4110 and/or a time-dated coupon 4120 to shop at the sponsor 4020.

The amount of the value returned and incentive may be determined by the sponsor. For example, a giftcard 4110 may be sent to bidder 4050 for a portion or all of the value of the bids 4060 spent. The value of the giftcard 4110 may be preferably between 50% and 100% of the value of the bids 4060 spent, but more preferably 100% of the value of the bids 4060 spent.

Similarly, an incentive, such as a coupon may be used to drive bids. The coupon may increase in value for each bid on an item. In some embodiments, the incentive may reset at the end of each auction. The bidder 4050 may then receive the highest incentive earned during the sponsorship period. The incentive may be delivered electronically or in physical form and limited to a time period. This limit may include being dated for a specific period of time, such as two days, to encourage quick redemption, for a minimum purchase and/or for a maximum purchase. The incentive range may be adjusted in light of the profit margin at the sponsor store. For example, a discount starting at 2% and ending at 20% may be appropriate for a sponsor with a profit margin above 20%. The coupon may also be exclusive, such that only the coupon or the giftcard may be used.

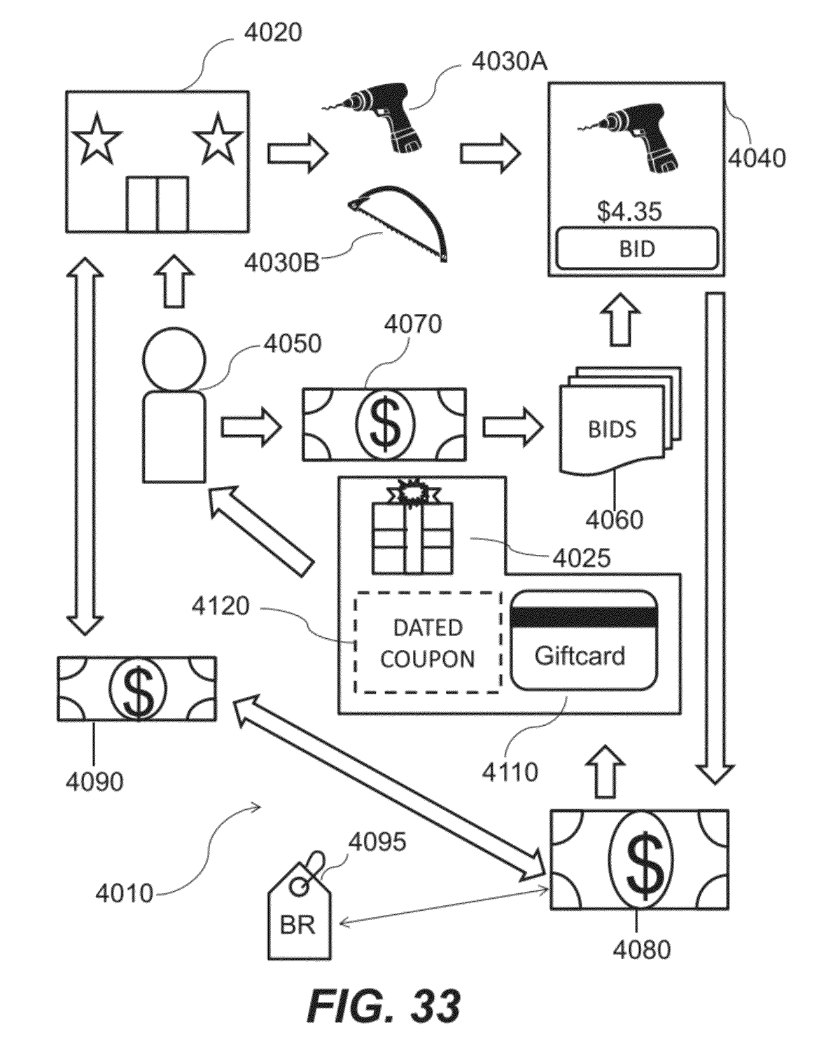

Turning to FIG. 34, a flowchart of a residual value bidding system is shown. Once a sponsor has been obtained 4130, their sponsored items may be loaded into the auction system 4140. The first item is loaded 4150 and placed up for auction 4160. Bids are taken 4170 until the item listing ends 180. If there are more items to auction 4190, then another item is placed up for auction 4160. Otherwise, the value of the bids is calculated 4200. A portion of the value of the bids may be returned to the sponsor 4210. The sponsor may then send a portion of the bid value to each bidder 4220, such as giftcards 4230.

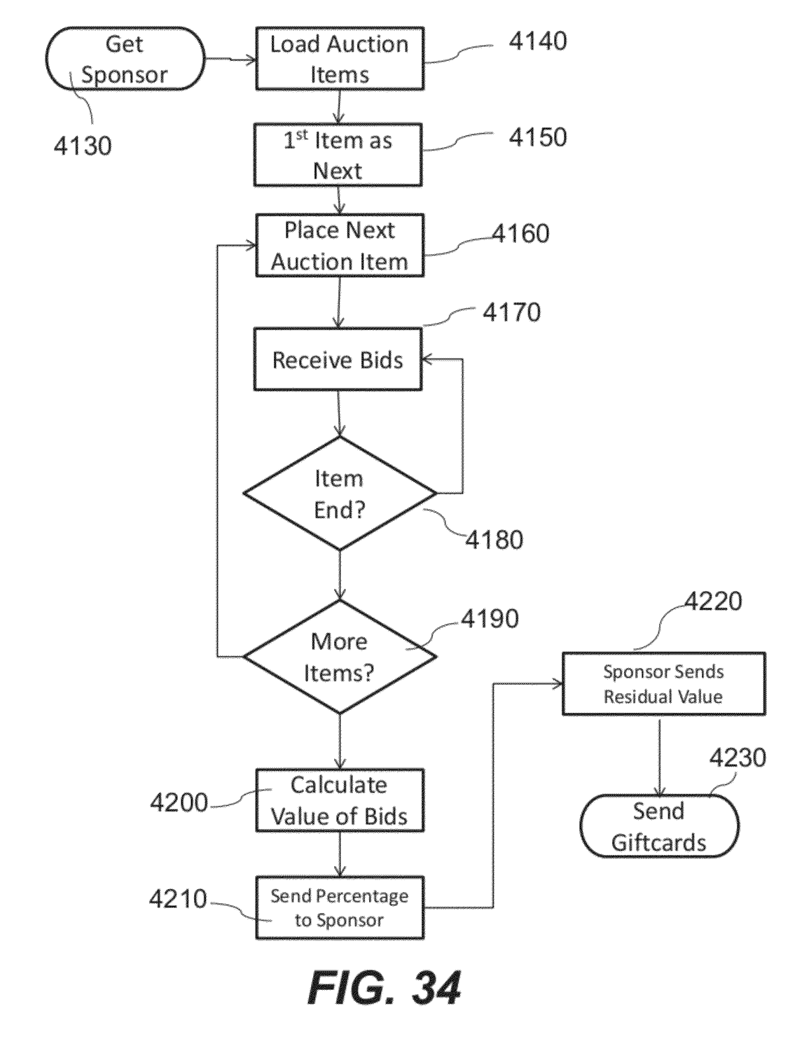

Turning to FIG. 35, a flowchart of a residual value bidding system with bidding rewards is shown. Similar to FIG. 34, a sponsor may be found 4130 with items to be loaded into the auction system 4140. The first item is placed in the queue for next 4150, thus placed up for auction as next 4160 and bids are taken 4170. If bids are received 4240, then the incentive may be increased 4250. If not, then a check may be made to see if the item's auction has ended 4260. If not, more bids may be taken 4170. If the item's auction has ended 4260, then if more items are available for auction 4270, the next item may be auctioned 4160. If no more items are available 4270, the value of bids may be calculated 4280 and the sponsor's share of the bid value be paid 4290. The residual value of the bids and the incentive may then be awarded to the bidders 4300, such as by a giftcard and coupon.

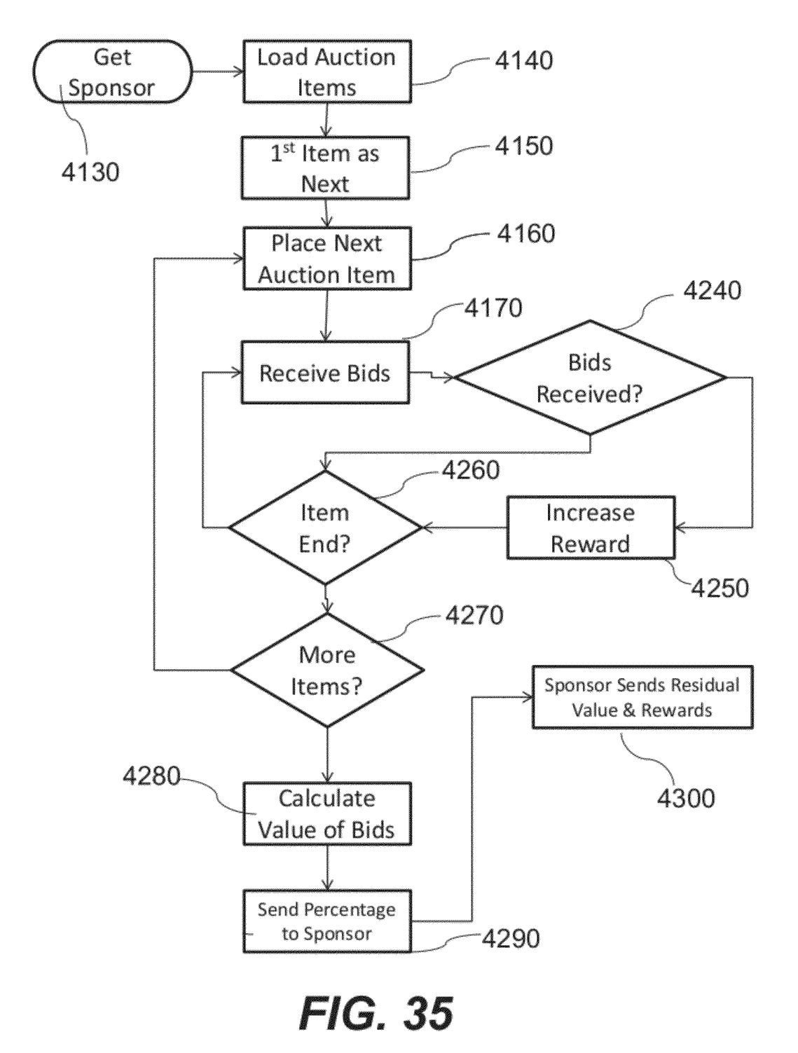

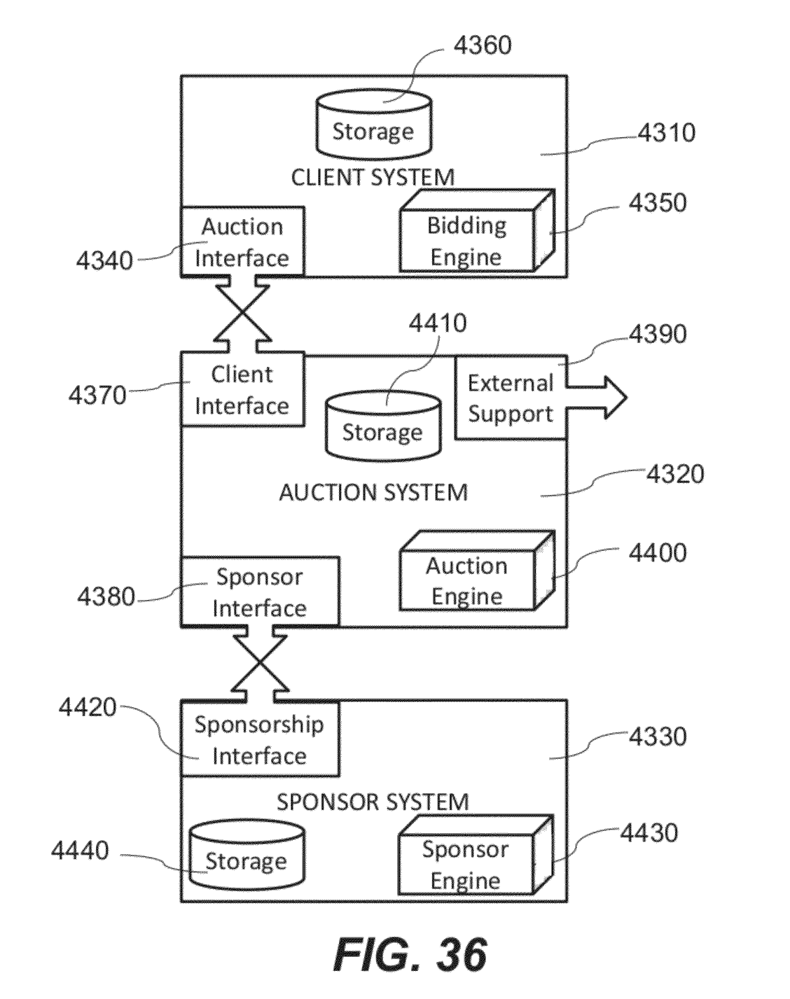

Turning to FIGS. 36 and 37, a system diagram of a residual value bidding system is shown. The residual value bidding system may contain one or more client systems 4310, an auction system 4320 and one or more sponsor systems 4330. Each system may have storage for keeping data, interfaces for communicating with external systems and engines for processing data and making decisions. FIG. 36 shows more of an overview of system components, while FIG. 37 shows a more specific embodiment.

In FIG. 36, a client system 4310 may have an auction interface 4340, a bidding engine 4350 and storage 4360. The auction interface 4340 may organize communication between the client system 4310 and the auction system 4320. The auction interface 4340 may allow the setup and continuing information flow relative to an auction. The bidding engine 4350 may process information and make decisions based on current and stored information. The bidding engine 4350 may thus enable timing and bidding in the ansynchronous environment of the internet. Storage 4360 may be used to pre-cache and retrieve history locally, which may free the communication link for the bidding process.

The auction system 4320 may include a client interface 4370, sponsor interface 4380, external support interface 4390, an auction engine 4400 and storage 4410. The client interface 370 may enable communication to the client system 4310. The client interface 4370 may send assets and auction information over predetermined or standard channels. The sponsor interface may enable communication with sponsor systems 4330. The sponsor interface 4420 may enable the sponsor to set up auctions and receive information about the auction status and redemption information. The external support interface 4390 may communicate with external systems, such as to enable tasks to be offloaded from the auction system. The auction engine 4400 may allow the auction system to process and make decisions relating to the auction system 4320, including auction setup, timing and winners. The storage 4410 may store information relating to the auction, such as information enabling auction history and fulfilling rewards.

The sponsor system 4330 may include a sponsorship interface 4420, sponsor engine 4430 and storage 4440. The sponsorship interface 4420 may enable communication from the sponsor system 4320 to the auction system 4330. The sponsorship interface 4420 may enable the sponsor to set up auctions and receive information about the auction status and redemption information. The sponsor engine 4430 may process the sponsor's information and make decisions based on the current information and information in storage 4440. Storage may store information relating to the sponsorship, including information caching and history.

Turning now to FIG. 37, a more specific discussion of an embodiment according to FIG. 36 is discussed. The auction interface 4340 in FIG. 36 may be further separated into a static interface 4450, dynamic interface 4460 and rewards interface 4470. The static interface 4450 may be used to load more static information, such as a webpage and pictures. The static interface 4450 may use technologies, such as html, to retrieve initial and/or large pieces of information. The dynamic interface 4460 may be used to modify the static information, such as JavaScript may modify a webpage. The rewards interface 4470 may facilitate the delivery of incentives and bid value to the client system. The rewards interface 4470 may directly deliver the rewards to the end user, such as by an email to print out, a barcode on a mobile device to scan, or a code to input.

The bidding engine 4350 may direct the operation of the client system. This may include client side software that makes the bidding system smooth. Thus, the bidding engine 4350 may include abilities to cache and estimate auction expiration times. The bidding engine 4350 may also store and display current incentives and/or incentives to beat based on past history.

The storage 4360 may store current information and history for the bidder to review. The storage may cache pictures, bidding history, current benefits, the maximum incentive achieved so far.

It should be recognized that the client system may be on a device that can display the auction to a user. This may include a mobile device, PC, smartphone, streaming display, remote access system or other system capable of interacting with the user.

An auction system 4320 may have a client-s interface 4480, a client-d interface 4490, a client-r interface 4495, an external support interface 4500, a sponsor interface 4510, a results interface 4520, an auction engine 4530 and storage 4540. Similar to the client interfaces 4450, 4460, 4470, the client-s (static) interface 4480, client-d (dynamic) interface 4490, client-r (results) interface 4495, the auction system may send static information, dynamic information and rewards information.

The external support interface 4500 may allow communication to external support systems. The external support systems may include login support, credit card processing, administrative interfaces, social media interfaces and other systems that would use an API (application programmer's interface), interactive manual input, and/or standard communication protocols to communicate with the auction system.

The auction system 4320 may also communicate with the sponsor system 4330 through a sponsor interface 4510 and results interface 4520. The sponsor interface 4510 may allow the sponsor to setup auction items and parameters about the auction, including retail values, suggest time limits, descriptions, incentives and fulfillment options. The results interface 4520 may allow the sponsor to receive information about the current and past status of the sponsored auctions. This may include fulfillment information, such as amounts of giftcards, values of coupons, shipping information for the products, and confirmations of receipt. The fulfillment information may also include information about creating the giftcard and/or coupons electronically, including barcodes, serial numbers, activation, or other electronic information.

The auction system 4320 may also include an auction engine 4530 and a rewards engine 4540. The auction engine 4530 may process and run the sponsored auction. This may include deciding winners, processing bids, sending messages to clients and sponsors. The rewards engine 4540 may process and run the redemptions of rewards earned in the auction. This may include electronically notifying winners, activating coupons and/or giftcards, and any changes in the rewards that may occur. The engines may store or retrieve current or historical information to/from storage, such as a database.

The sponsor system 4330 may include a set-up interface 4550, a fulfillment interface 4560, a sponsor engine 4570 and storage 4580. The set-up interface 4560 may allow the sponsor to prepare a sponsored auction, as described above. The fulfillment interface 4560 may allow a sponsor to fulfill and check on auction status as described above. The sponsor engine may allow the sponsor system to automate, process and/or prepare information that would allow the sponsor to set-up or fulfill the sponsored auction. The storage 4580 may store current and/or historical information.

While the components have been shown to be within a single system, it should be recognized that the individual components may be merged and/or further separated into individual units. The components may also reside and/or communicate across several units. These units may be physical devices, coding constructs, memory use, objects or other modules or systems that work together to accomplish a similar goal.

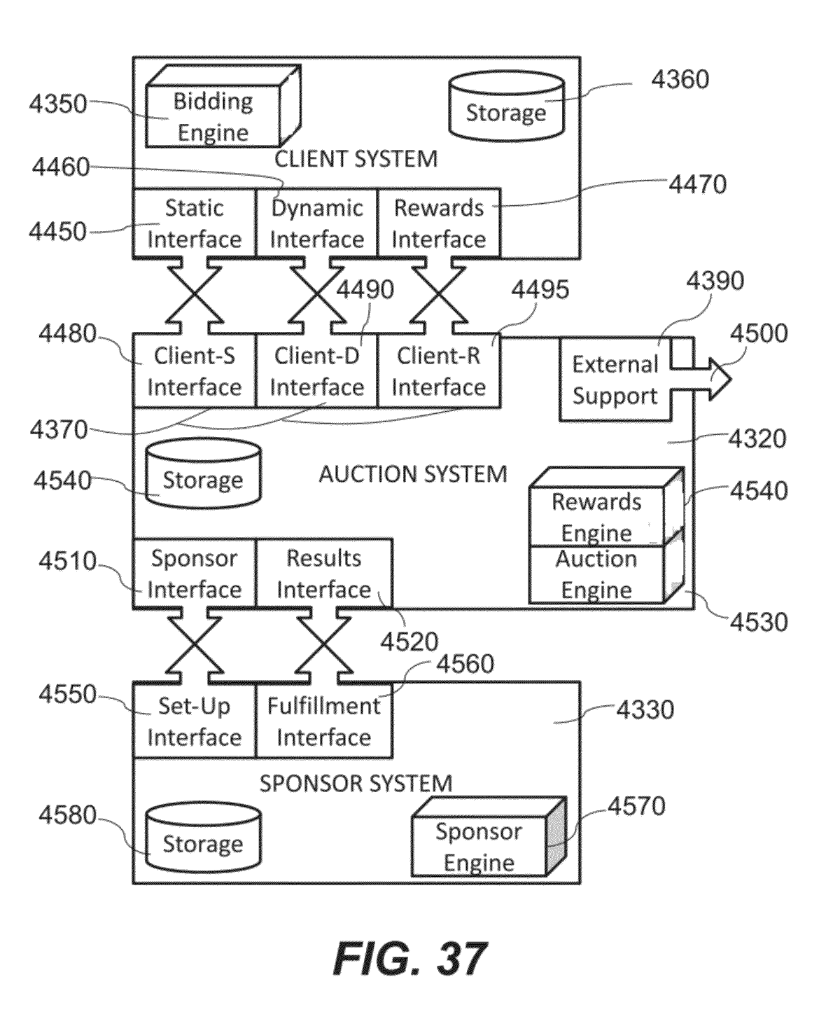

Turning to FIG. 38A, a residual value bidding module memory diagram is shown. A bidding module 4590 may contain information relating to a sponsored auction. Here, the module contains a product 4600, a timer 4610, an advertisement 4620, bid information 4630 and incentive information 4640. This information may be stored, such that it is available for the bidding system to process and display. The product 4600 may contain pictures and/or information relating to the product up for auction. The timer 4610 may contain the information about how much longer the auction may have to go. The advertisement 4620 may contain information that the sponsor would like to show, such as brand and/or company information. Bid information 4630 may contain current and/or historical bid information. Incentive information 4640 may include the incentives earned by bidders for the number of bids placed. Thus the sponsored auction may be placed in a module that may be contained and stored in storage and/or memory.

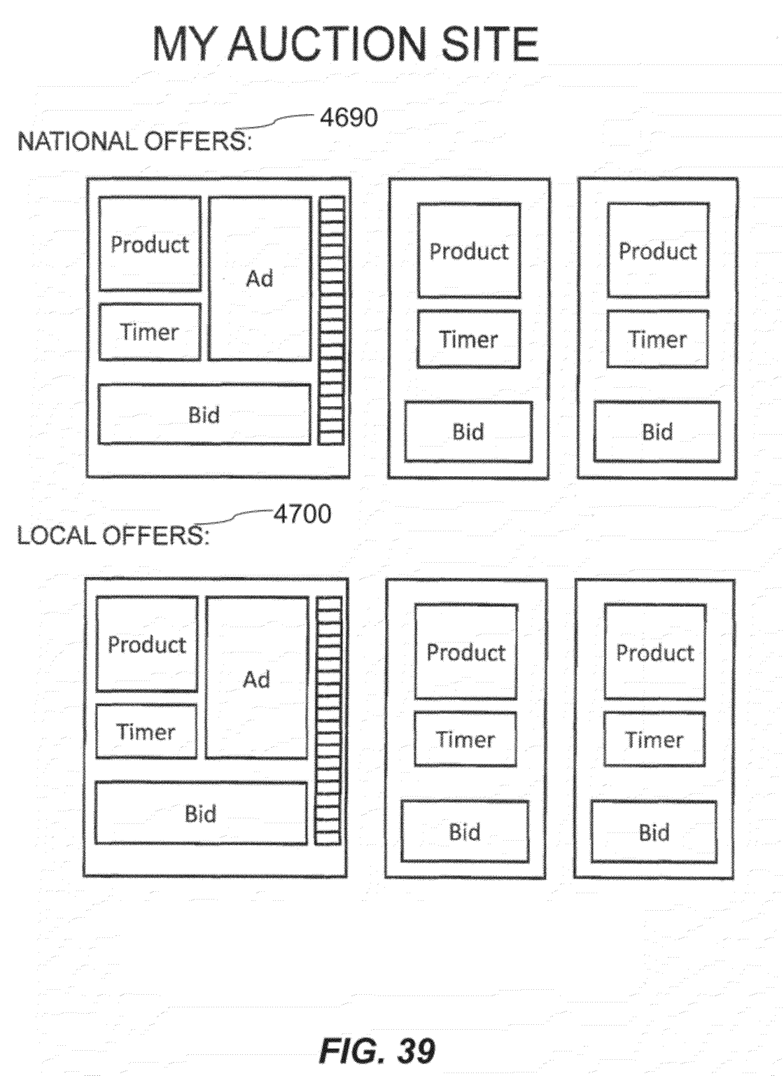

Turning to FIG. 38B, a residual value bidding module mock-up is shown. The website display may show the underlying information stored in FIG. 38A. The display may include a product 4650, a timer 4660, an advertisement 4670, bid information 4680 and incentive counter 4690. As a bidder clicks on the bid box 4700, the bid information 4690 may be incremented as well as the timer 4660. For every predetermined number of bids, the incentive counter 4690 may be incremented to a maximum. The advertisement 4670 may include multi-media information, such as pictures, text, video, flash and other multi-media. The advertisement 4670 may also contain a link to the sponsor's website, causing traffic to visit the sponsor's website. As the sponsored auction may be modular, the system replace one or more normal auctions with available sponsored auctions as seen in FIG. 39.

Turning to FIG. 39, a mock-up of a modular bidding site with residual value bidding system is shown. The sponsored auctions may include the option of localization. The localization may be based on geography (national 4690 and local 4700 are shown in FIG. 39), but also by demographics. Thus, a sponsor may choose to limit sponsored auctions to relevant geographic or demographic limits. This may allow a sponsor to select a market segment that may use the residual value to come in to the store and purchase beyond the residual value given by the auction.

The localization may be determined by multiple factors. The localization may use the account information to identify geography and demographic information, and thus require a user to be logged in to see the sponsored auctions. The localization may also be accomplished through IP address, packet inspection and/or speed tests, thus identifying the source of the internet requests. Further, the identification may be combined, such as to confirm the geography and/or likely demographics of the individuals.

As the sponsored auction is modular, the system may replace normal auctions with sponsored auctions upon recognition of the localization information. Thus, the site may look similar, and only change when relevant sponsored auctions are available.

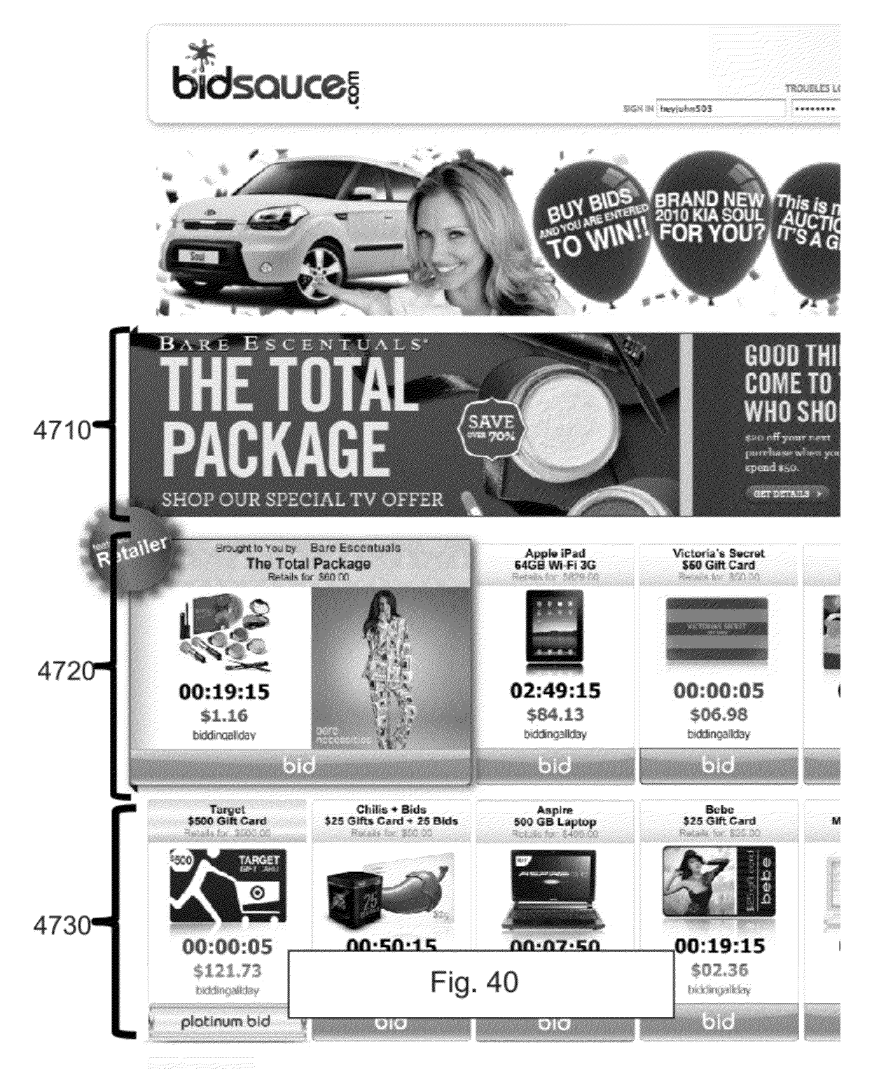

Turning to FIG. 40, a screenshot of a modular bidding site with residual value bidding system is shown. A sponsored auction may include a banner 4710 and the sponsored auction module 4720 on a website. Normal auctions 4730 may continue alongside the sponsored auction.

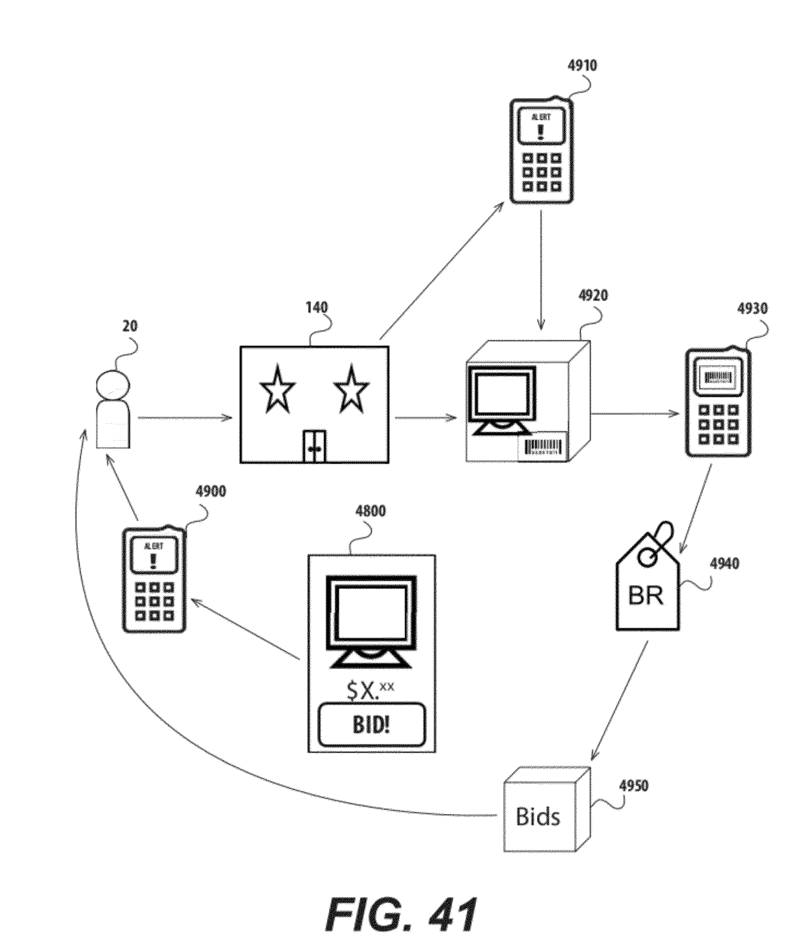

Turning now to FIG. 41, a store interaction diagram is shown. A customer 20 may go to a store 140. At the store 140, the customer may perform actions to interact with the store and service. In the example shown, the user may be notified of a bonus for scanning an item 4910 or just choose to suggest an item by scanning a UPC off of a product 4920. The scan may be sent by the user's mobile device 4930 to the service 4940. The service may reward 4950 the customer, such as by giving promo bids. Similarly, the user may choose to interact through surveys, pictures of items desired, self-made videos, comments or other customer feedback in addition to UPC scanning.

In some cases, the service 40 may analyze past store interaction and/or past bidding behavior 4800 and send an alert 4900 based on the past behavior. The alert may include an incentive to buy, such as sale information, a coupon, bonus bids or other value to the customer. In one embodiment, the alert is related to a UPC scan performed by the customer informing the service of a desired product. The alert serves as another way to use online information to drive traffic to a store.

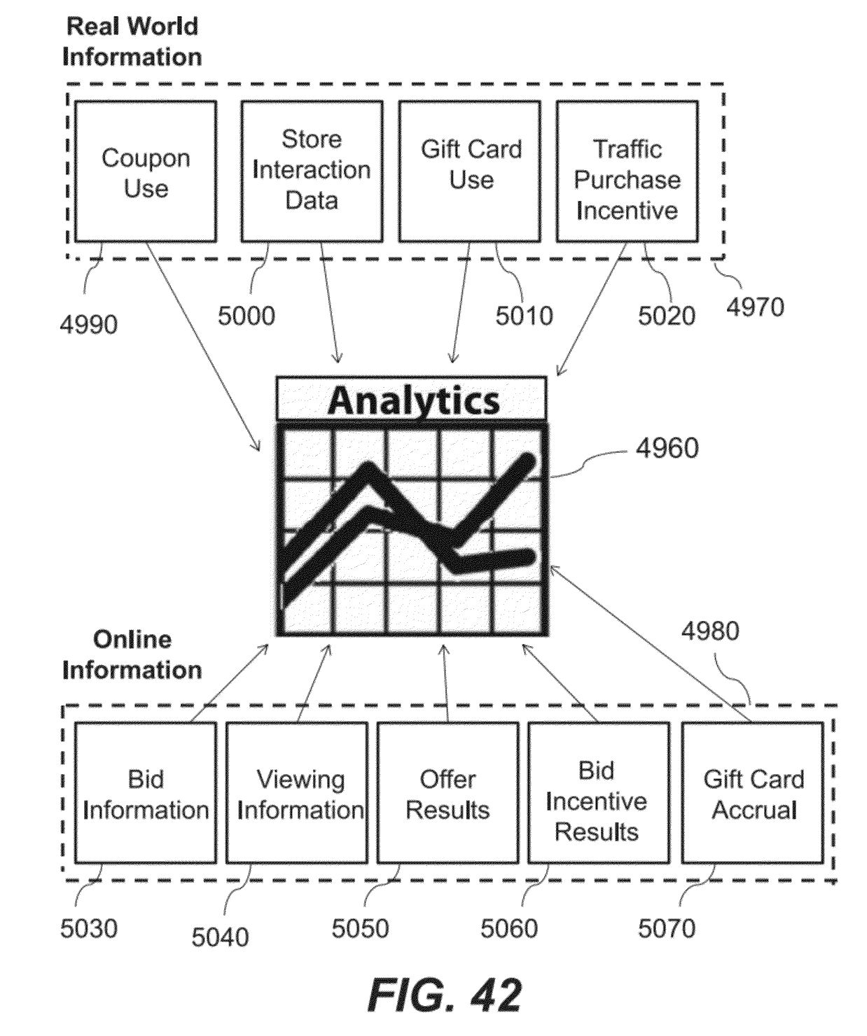

Turning now to FIG. 42, a diagram of multi-system analytics is shown. The multi-system analytics 4960 may be useful because of the information from the real world 4970 combined with the information from the online world 4980. Real world data may include coupon use 4990, store interactions 5000, gift card use 5010, and purchase incentives 5020. Online data may include bid information 5030, viewing information 5040 (including product likes), offer results 5050, bid incentive results 5060 and gift card accrual 5070. This information may be dissected and combined to drive traffic back and forth from the online to the real world.

For example, customers may scan a barcode, which may tell the sponsor about an item's popularity. The sponsor may put the item up for auction, which may cause significant bidding. For those that do not win, the offer may be made to purchase the item. If few people take the offer, the sponsor has a second chance to send out purchase incentives and/or offers reducing the price to the customers. If the sponsor sends the offers or incentives out in groups, the sponsor may be able to tease out the supply and demand curve for their product and potentially optimize for profitability. This may be a possibility because the information of both online and offline behavior has been tracked.

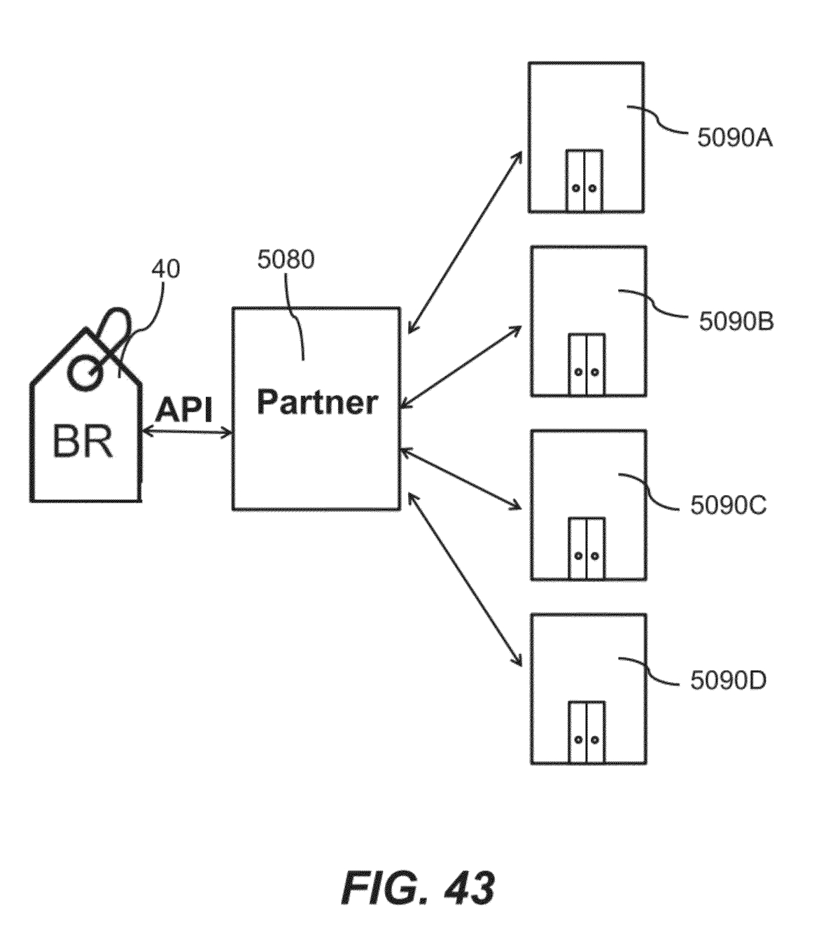

Turning now to FIG. 43, a diagram of an API integration system is shown. The service 40 may connect with a partner 5080 through an API. The partner may also connect with other entities 5090A, 5090B, 5090C, 5090D and 5090F and provide access to their value and information. Information may be transmitted in a standard fashion such that manual processes may be eliminated and systems become more integrated.

For example, the service 40 may connect with a partner 5080 that activates gift cards. The service may request gift card codes and/or information about the amount of money on gift cards from the partner 5080. In turn, the partner 5080 requests activation of gift cards and/or receives information about the current status of gift cards. The service may then report that information back to its customers.

In one embodiment, the service 40 requests creation of a new gift card from partner 5080 and provides payment terms. The partner 5080 requests a new gift card from a store 5090A and activation for a certain amount. The store 5090A responds with a success or fail message and the associated gift code. The partner 5080 relays that information to the service 40, which may then provide electronic access to the gift card to its customer.

There is thus disclosed an improved residual value bidding system with online and offline interaction. It will be appreciated that numerous changes may be made to the present invention without departing from the scope of the claims.

What is claimed is:

1. A system for conducting an auction, the system comprising:
an auction module allowing customers to bid on items;
a residual value module returning a portion of the value of bids to a customer who used the bids; and
a stored value module providing the returned portion of the bids in a form that is acceptable to spend at a store.

2. The system of claim 1, wherein the residual value module is programmed to use the number of bids placed by the customer to determine the portion of the value of bids returned to that customer.

3. The system of claim 2 wherein the portion of the value of the bids to be returned to the customer in a stored value container.

4. The system of claim 1, wherein the stored value module can be accessed by the customer online and offline.

5. The system of claim 1, wherein the system comprises a module for detecting the use of a bid history of the customer while in a store and notifying the store of items on which the customer has bid.

6. A method of auction, the method comprising:
providing an auction of an item;
receiving payment for bids from a customer;
returning a portion of the payment of the bids by the customer to the customer in a stored value container.

7. The method of claim 6, wherein returning a portion of the payment comprises giving the customer a stored value card.

8. The method of claim 7, wherein the method further comprises advising a store of items on which the customer bid when the customer uses the stored value card.

9. A method for conducting an auction, the method comprising:
displaying an item to be auctioned via a website over the internet;
notifying potential participants in the auction that the person who makes the most bids in a limited number of time wins the auction; and
receiving bids in an accelerated manner over the internet to determine the winner of the auction.

10. A system of conducting an auction, the system comprising:
a module for displaying an item to be sold at auction; and
a module for turbo bidding, wherein the module is programmed to determine which participant in the auction has placed the most bids during a given window of time and to declare that person the winner;

11. The system of claim 10 further comprising a module for storing a residual value of bids made by participants.

12. The system of claim 10 further comprising an analysis module which reviews the bidding information to determine a winning bidder.

14. The system of claim 10, further comprising a fraud detection module for determining whether bidders have used unauthorized means to win a bid.

15. The system according to claim 10 further comprising at least one modules selected from the group consisting of a messaging module, a content module, a bid detection module, a fraud detection module, a bid analysis module, and a person counting module.
